(19) United States
(12) Patent Application Publication
(10) Pub. No.: US 2004/0141011 A1
(43) Pub. Date: Jul. 22, 2004

(54) Graphical user interface features of a browser in a hand-held wireless communication device

(76) Inventors: Paul A. Smethers, Seattle, WA (US); Jonathan M. Wulff, Los Gatos, CA (US)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/754,118

(22) Filed: Jan. 7, 2004

Related U.S. Application Data
(62) Division of application No. 09/825,383, filed on Apr. 2, 2001.
(60) Provisional application No. 60/216,549, filed on Jul. 7, 2000.
(60) Provisional application No. 60/226,780, filed on Aug. 21, 2000.

(51) Int. Cl. G09G 5/00

(52) U.S. Cl. 345/810

(57) ABSTRACT

A microbrowser in a mobile communications device generates a Graphical User Interface (GUI) including features that make the device more user-friendly. These features address problems associated with a device that has relatively few input keys and restrictive functionality for cursor movement and pointing, such as a two-arrow key device. The GUI features include: a combined browser-application menu that includes a dismiss bar and browser options represented by horizontally placed icons; a separate browser menu accessible from the title bar of a displayed screen; an auto-jump feature that automatically highlights the next actionable control after a control has been edited; a control-sensitive softkey menu on the secondary softkey that changes according to the control currently in use; table navigation that allows more efficient navigation through table or calendar entries using two arrow keys; and a non-scrollable header with actionable controls.

This application is a divisional of U.S. patent application Ser. No. 09/825,383, filed on Apr. 2, 2002, which claims the benefit of U.S. Provisional Patent Application No. 60/216,549, filed on Jul. 7, 2000, and U.S. Provisional Patent Application No. 60/226,780, filed on Aug. 21, 2000, both of which are entitled, “Graphical User Interface Features of a Browser in a Hand-Held Wireless Communication Device,” and all of which are incorporated herein by reference.

### FIELD OF THE INVENTION

The present invention pertains to wireless communication devices. More particularly, the present invention relates to Graphical User Interface (GUI) features of a microbrowser in a hand-held wireless communication device.

### BACKGROUND OF THE INVENTION

For people and businesses requiring instant access to information, the Internet and intranets have provided a vehicle for near real-time delivery of information from an enormous number of sources. For many of those same individuals, two-way mobile communication devices, such as cellular telephones, two-way pagers, Personal Digital Assistants (PDAs), Personal Information Managers (PIMs), and other handheld computing devices, have provided a way of communicating regardless of locality. In recent years, these two rapidly-advancing technologies have come together, such that the two-way mobile communication device has become one of many entry points into the Internet and intranets.

Devices used to access the Internet (or Intranets) generally have certain features in common, whether they sit on a desktop or are held in the palm of the hand. One feature such devices may have in common is that they may be used to display hypermedia content, such as web pages. To do so, network servers and network personal computers (PCs) normally use standard web protocols and mark-up languages, such as Hypertext Transport Protocol (HTTP) and Hypertext Markup Language (HTML), respectively. Mobile devices generally use wireless protocols, such as Wireless Access Protocol (WAP) or Handheld Device Transport protocol (HDTP), and wireless markup languages, such as Wireless Markup Language (WML) and Handheld Device Markup Language (HDML), to accomplish the same task.

One problem with using many conventional mobile devices to access the Internet is the lack of user-friendliness of their user interfaces. Because these devices are designed to be mobile, they normally have very small displays, compact keypads and, commonly, only a limited provisions for pointer/cursor movement. For example, such devices commonly have only two directional arrow keys (e.g., Up and Down arrow keys) to control pointer or cursor movement and highlighting. Such devices are referred to herein as “two-arrow” devices. This pair of keys can specify cursor or pointer movement only along one axis at a time. In contrast, conventional PCs commonly use pointing devices that can specify pointer or cursor movement simultaneously and directly along two perpendicular axes (i.e., horizontally and vertically), such as a mouse, trackball, touchpad, or the like. Such pointing devices are referred to herein as “direct” pointing devices. These restrictions exist on mobile devices because the mobile devices are designed to be relatively inexpensive and small so as to fit into the palm of the hand.

### SUMMARY OF THE NVETION

The present invention includes a hand-held wireless communication device that includes a microbrowser with improved graphical user interface features, as well as a method and other apparatus for providing such features. The hand-held wireless communication device may lack a direct pointing device.

In one aspect of the invention, the microbrowser displays a dual browser/application menu on a display in response to a user input. The dual browser/application menu includes multiple icons arranged in a row, each of which represents a different browser-specific function. The dual browser/application menu also includes multiple substantially text-based items arranged in a list in proximity to, but oriented differently from, the icons, wherein each of the substantially text-based items represents a different application-specific function.

In another aspect of the invention, the microbrowser persistently displays an icon in a predetermined part of each of multiple display screens of hyperlinked content. The icon represents a pop-up browser menu that contains multiple items representing browser-specific features. The microbrowser responds to user selection of a predetermined selectable item in any of the display screens by providing a user-perceivable indication that the pop-up browser menu is currently selectable. The microbrowser responds to a selection input when the pop-up browser menu is currently selectable by displaying the pop-up browser menu.

In another aspect of the invention, the microbrowser displays multiple user-editable controls on the display and places one of the controls in an editable mode, to enable editing of the control by a user. The microbrowser then receives a user input for editing the control. In response to a single user input indicating that editing of the control is complete, the microbrowser automatically places a next one of the controls in an editable mode without requiring additional user input.

In another aspect of the invention, in a hand-held wireless communication device which lacks a direct pointing device, the microbrowser displays two or more softkeys on the display concurrently with displaying any of the user-editable controls. A first softkey is operable to place any of the controls in an editing mode. A second softkey is operable to display a menu when any of the controls is in an editing mode. The content of the menu varies according to which of the controls is currently in an editing mode. In a variation of this aspect of the invention, one of the controls may be edited in each of a text input mode, a numerical input mode, and a symbol input mode. In that variation, the menu associated with the second softkey includes multiple items, which are selectable to allow a user to switch between the aforementioned editing modes.

In another aspect of the invention, in a hand-held wireless communication device which lacks a direct pointing device, the microbrowser displays a table having multiple rows, each of which has multiple user-editable cells. The microbrowser sequentially enables the rows for selection in response to successive user inputs from the pointing device. The microbrowser further selects one of the rows which is enabled for selection in response to a user input. When one of the rows has been selected, the microbrowser sequentially enables cells within the selected row for selection, in response to successive user inputs at the pointing device.

In another aspect of the invention, in a hand-held wireless communication device which lacks a direct pointing device, the microbrowser displays a mark-up language based screen on the display. The mark-up language based screen includes a body and a static area located adjacent to the body. The body is scrollable in response to user inputs from the pointing device. The static area includes a control operable in response to user inputs, but is non-scrollable, so as to remain visible when the body is scrolled.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment in which a mobile communication device may be used;

FIG. 2 is a schematic view of a two-way mobile communications device that may be used to access the Internet;

FIG. 3 is a block diagram of the principle components of the two-way mobile communications device;

FIGS. 4A through 4F are a sequence of screens generated by the browser of the mobile device, showing a combined browser and application menu;

FIGS. 5A through 5F are a sequence of screens generated by the browser of the mobile device, showing a Browser Menu that can be accessed from the title bar;

FIGS. 6A through 6D show a series of screens for an example of the operation of the auto-jump feature;

FIGS. 7A through 7E show a series of screens for a second example of the operation of the Auto-Jump feature;

FIGS. 8A through 80 show a series of screens for an example of how the control context sensitive menu feature operates;

FIGS. 9A through 9E show a series of screens for an example that demonstrate how this table navigation feature works;

FIGS. 10A through 10K show a series of screens for an example of the operation of the calendar navigation with smart selection of dates; and

FIGS. 11A and 11B show a pair of screens for an example of how the non-scrollable header feature operates;

FIGS. 12A through 12D show a sequence of screens illustrating an example of the operation of the Growing Text Box feature;

FIGS. 13A through 13U show a sequence of screens illustrating an example of the operation of the Auto-Fill feature;

FIGS. 14A through 14I show a symbol entry feature of the browser; and

FIGS. 15A through 15D show a dual feedback feature for improving usability of softkey activated controls.

### DETAILED DESCRIPTION

A method and apparatus for providing a microbrowser with a Graphical User Interface (GUI) in a hand-held, wireless, mobile communication device are described. Note that in this description, references to “one embodiment” or “an embodiment” mean that the feature being referred to is included in at least one embodiment of the present invention. Further, separate references to “one embodiment” in this description do not necessarily refer to the same embodiment; however, neither are such embodiments mutually exclusive, unless so stated and except as will be readily apparent to those skilled in the art.

A microbrowser in a hand-held mobile communications device can be designed to provide a GUI that is more user-friendly than those of prior mobile communications devices, as described below. As used herein, “hand-held” means designed to be held in the palm of the hand. A “browser” is a component that allows a user to access a web of hyperlinked content, such as the World Wide Web on the Internet. A “microbrowser” is a type of browser that is designed for use in a hand-held device.

The GUI features described herein address problems associated with a mobile communications device that has relatively few input keys, and in particular, restrictive functionality for cursor movement and pointing. As described in greater detail below, the GUI features may include: a combined browser-application menu that includes a dismiss bar and browser options represented by horizontally displayed icons; a separate browser menu accessible from a title bar of a displayed screen; an auto-jump feature that automatically highlights the next actionable control when a control is done being edited; a control-sensitive softkey menu that changes according to the control currently in use; table navigation that allows more efficient navigation through table or calendar entries using two arrow keys; a non-scrollable header with actionable controls, to allow the use of frames in conjunction with markup content; an improved text input feature; an improved symbol entry feature; and improved (dual) feedback when using soft key controls.

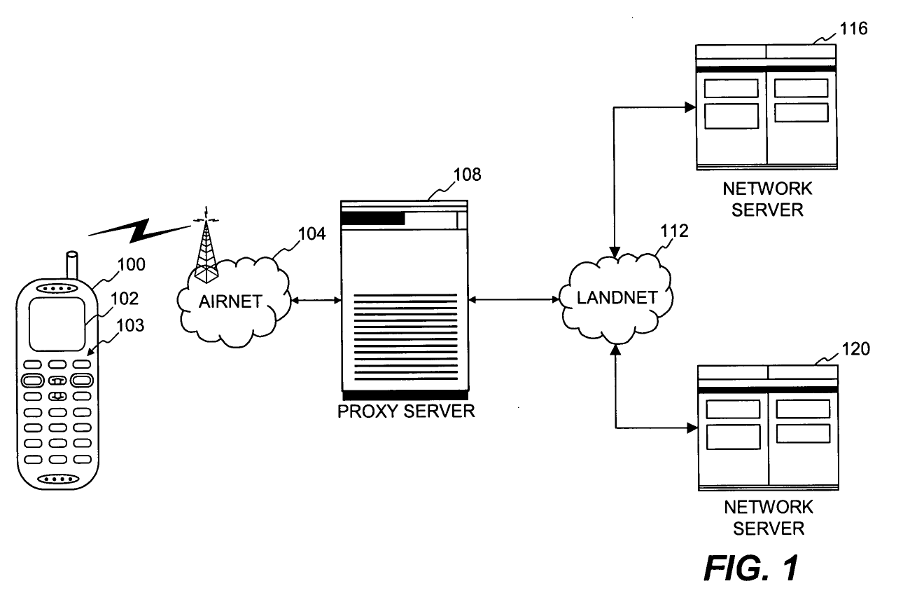

FIG. 1 shows a network environment in which a mobile communication device (or simply “mobile device”) can be used. Mobile device 100 may be of any of the types of mobile devices mentioned above, such as a wireless telephone, for example. To facilitate explanation, the example of a wireless telephone is used at various points in the following description. Mobile device 100 is configured to retrieve remotely stored hypermedia information, such as WML documents, HTML documents, Compact HTML (cHTML) documents, Extensible Markup Language (XML) documents, or HDML documents, from one or more network server device, shown as network servers 116 and 120. Network Servers 116 and 120 may be, for example, conventional personal computers (PCs) or computer workstations. Mobile device 100 has a display 102 and a keypad 103.

Mobile device 100 also includes and executes a microbrowser (not shown), which is software that allows the user of mobile device 100 to access the Internet, including browsing the World Wide Web or any other “web” of hypermedia content. One example of a microbrowser that may be used for this purpose is the UP.Browser microbrowser from Openwave Systems Inc. of Redwood City, Calif. The microbrowser may be stored in memory within the mobile device 100. The microbrowser generates a GUI via display 102 to enable the user of the mobile device 100 to access and retrieve hypermedia information from network servers 116 and 120. Various features of the GUI, which make the microbrowser more user-friendly, are described below.

The communication path between mobile device 100 and network servers 116 and 120 includes a wireless communication network (“airnet”) 104, a proxy server 108, and a land-based network (“landnet”) 112. Airnet 104 is a network such as a Cellular Digital Packet Data (CDPD) network, a Global System for Mobile (GSM) network, a Code Division Multiple Access (CDMA) network, or a Time Division Multiple Access Network (TDMA) network. The communications protocols used by airnet 104 may include, for example, WAP and/or HDTP. Landnet 112 is a land-based network that may be or include the Internet, an intranet, or a data network of any private network, such as a Local Area Network (LAN). The communication protocol supporting landnet 112 may be, for example, Transmission Control Protocol (TCP/IP), HTTP, or Secure HTTP (sHTTP).

Proxy server device 108 acts a bridge between airnet 104 and landnet 112. Proxy server device 108 may be, for example, a conventional computer workstation or PC. Although shown as a physically separate device, proxy server 108 may be implemented in a network server device (e.g. network servers 116 or 120) with hardware and software well known in the art providing the connection between airnet 104 and landnet 112.

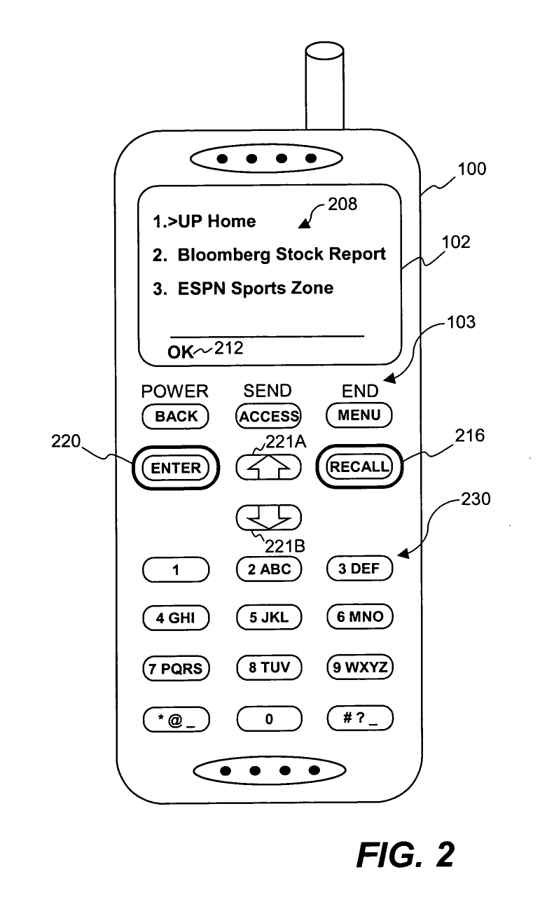

FIG. 2 is a schematic view of the mobile device 100, according to one embodiment. As shown, mobile device 100 includes a display 102 and a keypad 103. Display 102 may display hypermedia information, such as information 208, and, depending on the current mode of the device, one or more softkey labels, such as softkey label 212. Function keys 216 and 220 can be used to activate softkeys represented by the softkey labels (when enabled).

It is useful to now define what is meant by a “softkey”. A softkey is a user-operable feature that is analogous to a physical (i.e., purely hardware-based) key or button, but which is formed by a combination of a physical key (e.g., either of keys 220 and 216 in FIG. 2) and a softkey label displayed on the display 102. Because not all features can be easily mapped to specific keys on small, wireless devices, the use of softkeys has become commonplace for manipulating items on the screen and initiating functions. Such devices typically have no direct input mechanisms (e.g., pen-based input or mouse input (such as on a PDA or PC respectively). To compensate, softkey functions are indicated by labels displayed directly above the physical (hardware) keys that operate the softkey functions. To facilitate description, softkey labels are sometimes referred to herein simply as “softkeys”. It will be understood, however, that “pressing” or otherwise activating a softkey is accomplished by pressing the physical key which corresponds to the softkey function, i.e., is located below the corresponding softkey label.

Referring still to FIG. 2, keypad 103 includes alphanumerical keys 230 (such as for dialing a telephone numbers and entering links), function keys 216 and 220, Up arrow key 221A, and Down arrow key 221B. Arrow keys 221A and 221B are used to navigate through information displayed on display 208, such as to move a selection indicator (e.g., highlighting), cursor, pointer, or other indicator, or to scroll the display.

The hypermedia information 208 shown in FIG. 2 includes a list of selectable identifiers (e.g. “UP Home”) having corresponding Uniform Resource Identifiers (URIs). Hypermedia information 208 may be, for example, a WML file, or “deck”, including one or more WML cards. In certain modes of operation, activating function key 220 while a displayed item is selected (e.g., highlighted) causes mobile device 100 to retrieve and display a WML card associated with a URL of that item. In addition, using the alphanumerical keys 230, the user may enter a URL manually to access hypermedia content. To facilitate this operation, the microbrowser may provide several different input modes, such as a number input mode, an alphabetic input mode, a symbol input mode, and a URL input mode.

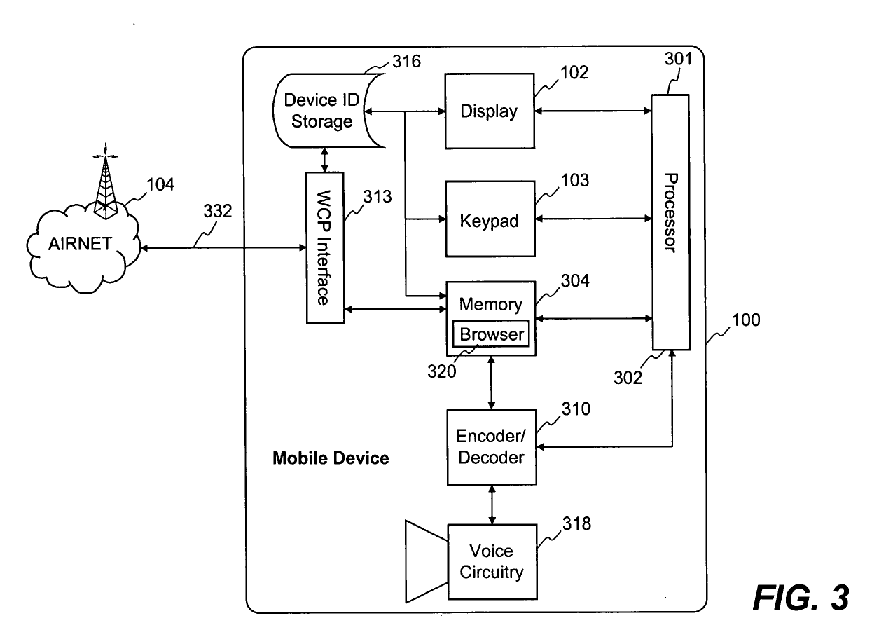

FIG. 3 is a block diagram showing the principle components of mobile device 100, according to one embodiment. The mobile device 100 includes a processor 301, which may be or may include any of: a general- or special-purpose programmable microprocessor, Digital Signal Processor (DSP), Application Specific Integrated Circuit (ASIC), Programmable Logic Array (PLA), Field Programmable Gate Array (FPGA), etc., or a combination thereof. Mobile device 100 includes a Wireless Control Protocol (WCP) interface 313 that couples to a carrier network via airnet 104 to receive incoming and outgoing signals. Device identifier (ID) storage 316 stores and supplies to WCP interface 313 a device Id which identifies mobile device 100 to outside entities (e.g. proxy server 108). The device ID is a specific code that is associated with mobile device 100 and directly corresponds to the device ID in the user account typically provided in an associated proxy server device, such as proxy server 108.

In addition, mobile device 100 includes memory 304 that stores data and/or software for performing many of the processing tasks performed by mobile device 100, including the microbrowser (or “browser”) 320, when executed by processor 301. These tasks include: establishing a communication session with a proxy server device via wireless link 332 and airnet 104; receiving user inputs from keypad 103; requesting and receiving data from the carrier network; and displaying information on the display 102. Hence, memory 304 may represent one or more physical memory devices, which may include any type of Random Access Memory (RAM), Read-Only Memory (ROM) (which may be programmable), flash memory, non-volatile mass storage device, or a combination of such memory devices. Memory 304 is also coupled to WCP interface 313 for the establishment of a communication session and the requesting and receiving of data.

The mobile device 100 also includes voice circuitry 318 for inputting and outputting audio during a telephonic communication between the user of mobile device 100 and a remote party. Voice circuitry 318 may include, for example, sound transducers, analog-to-digital (A/D) and digital-to-analog (D/A) converters, filters, etc., such as are well-known in the art. An encoder/decoder 310 is coupled between the processor 301 and the voice circuitry 318 for encoding and decoding audio signals.

What follows is a description of various features of the GUI generated by the microbrowser (hereinafter “browser”) 320 of the mobile device 100, any or all of which may be implemented in a given embodiment, to make the mobile device 100 more user-friendly. It will be readily apparent to those skilled in the art how to implement these GUI features in program code, from the following description of the user-perceivable characteristics of these features. A browser that incorporates these features may be written in a conventional programming language that is currently used to implement microbrowsers for mobile devices. The various features described below do not all have to be implemented in a given device, although doing so may result in the best performance from an end user's perspective.

Note that as an alternative to the browser 320 generating the following GUI features, these features can instead be provided by a remote device (e.g. proxy server 108 or servers 116 or 120), such that the mobile device only receives and displays these features to the user.

I. Dual Browser-Application Menu

Applications on mobile devices often require the accessibility of both application-specific features and browser-specific features. It is desirable to provide both types of features in a single menu that is always accessible. This approach provides the user with a single menu or screen for every action, making the application more efficient for the user. However, several usability issues arise in attempting to implement both an application menu and a browser menu. Separate menus may require two dedicated keys, one for each menu. Most mobile devices cannot afford to make these keys available. Consequently, one or both menus may be hidden under non-intuitive keys on the device, or both menus may be combined and assigned to a single menu that confuses the user. A combined menu with both browser and application options can be confusing, because the user may not be able to readily distinguish between application menu items and browser menu items. For example, if the menu provides the option, “Exit”, it may not be clear whether the option will result in exiting the browser or just the current application.

In addition, users are sometimes confused about how to dismiss (exit) menus using the limited number of keys on the mobile device. It may be easy to bring up the menu, but not always clear how to dismiss it without making a selection. Arrow keys usually highlight items only, and a Select or Enter key selects the item the user highlighted. If the user wants to leave the menu without selecting anything, he may be confused about how to do this. Merely placing “Cancel” on every menu is not a good solution, because the user tends to think he can use the menu to “Cancel” an application operation, not the menu. Similar confusion may arise for other terms such as “Dismiss” (i.e., whether it dismisses the application or the menu), “Delete”, etc.

Consequently, the GUI of a mobile device, such as mobile device 100, may provide a combined browser-application menu, as described below, to allow one menu to meet both browser-specific and application-specific needs. The combined application menu and browser menu is particularly suited for devices that have no direct pointing device (e.g., a mouse), such as those mobile devices having only two-way arrow cursor keys (e.g., Up and Down arrow keys 221A and 221B) and one selection key (e.g., a softkey). As used herein, the term “direct” pointing device means a pointing device that can specify position coordinates and/or can move a pointer, cursor, selection indicator or the like simultaneously along at least two perpendicular axes. The menu itself can be accessed from either a primary activation key or, as in the examples provided herein, a secondary softkey.

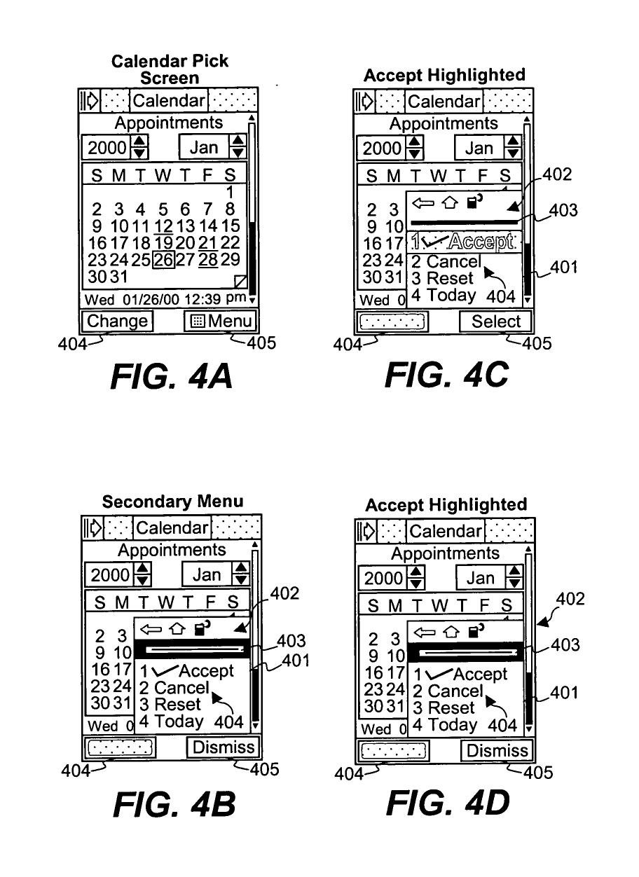

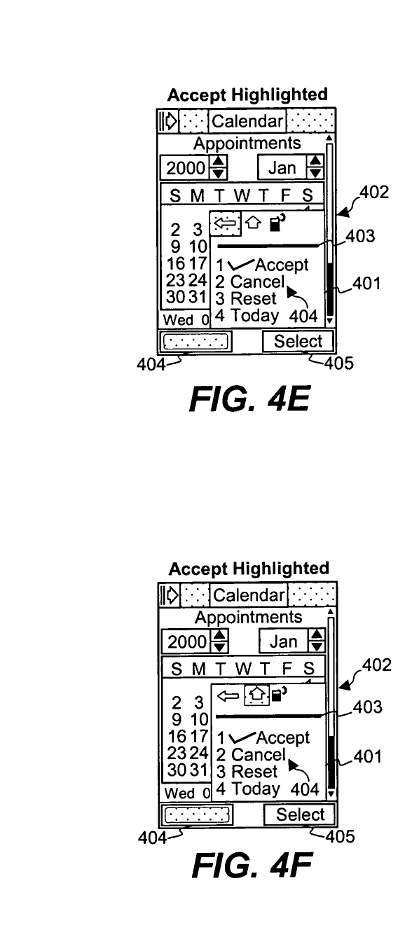

FIGS. 4A through 4F show a sequence of screens generated by the browser of the mobile device, showing a combined browser-application menu. As shown in FIGS. 4B through 4F, the combined menu 401 includes browser options in a Browser Bar 402, which includes a set of icons representing browser functions in a row across the top of the menu. These icons are clearly differentiated from the application options, which are listed as text in a vertical list below the Browser Bar 402. The icons of the Browser Bar 402 consume little space so as to avoid the browser features dominating the menu. The menu 401 also includes a Dismiss Bar 403 that the user can select to dismiss the menu 401. The Dismiss Bar 403 provides improved menu usability for limited keyboard devices. The menu 401 also includes application menu options 404 (the options below the Dismiss Bar) associated with the current application. Note that this type of menu look and feel can also be used for functions other than just browser and application menu items.

Table 1 describes an example of the operation of the combined browser-application menu in conjunction with FIGS. 4A through 4F.

TABLE 1
Browser-Application Menu

| Action | Result/Explanation |
|---|---|
| Start -- FIG. 4A. | The left (primary) softkey 404 |
| Begin in the “Calendar | is available for the application |
| Pick” screen, as shown. | (i.e. to change the highlighted |
| | spin control), and the right |
| | (secondary) softkey 405 is |
| | available for an application- |
| | dependent menu. Softkeys |
| | 404 and 405 can be activated |
| | using function keys 220 and |
| | 216, respectively (FIG. 2) |
| | on mobile device 100. |
| Softkey 2 Pressed. | FIG. 4B. |
| The user presses the | The left softkey 404 is now |
| right softkey 405 to | disabled, since it is no longer |
| bring up the combined | available while the softkey |
| browser-application | menu is up. The user can only |
| menu 401. | scroll Up and Down, and use |
| | the right softkey 405 to select |
| | an item. |
| | The right softkey is labeled |
| | “Dismiss”, since the |
| | Dismiss Bar is selected. The |
| | Dismiss Bar 403 is a visual |
| | way to indicate to the user |
| | that they can dismiss a menu |
| | with no harm. |
| Down Pressed. | FIG. 4C. |
| The user presses the | Scrolling down is how the user |
| down arrow key 221B | highlights menus. The user can |
| (FIG. 2) to highlight | continue to scroll down to |
| the next menu item | highlight other menu items. The |
| down the list. | user can at any time press the |
| | right softkey 405 to select |
| | that item and cause its action. |
| | The softkey label changes to |
| | “Select” once a menu item |
| | is selected. |
| | The menu items on the bottom |
| | are the application dependent |
| | menus. They are visually |
| | distinguishable by their text |
| | labels below the Dismiss Bar 403. |
| Up Pressed. | FIG. 4D. |
| The user presses the | The user can scroll back up |
| up arrow key 221A | to put the menu in its previous |
| to highlight the | state and dismiss the menu |
| previous menu item up, | without an action. |
| which is the Dismiss | |
| Bar 403. | |
| Up Pressed. | FIG. 4E. |
| The user presses the | The Browser Bar 402 is above |
| up arrow key 221A | the Dismiss Bar 403. It allows |
| to highlight the | the user to select browser menu |
| previous menu item up, | options that occur for any |
| which is the first | screen. Since Browser menu |
| icon in the Browser icon | items are common on all screens, |
| bar 402. | they are displayed with icons |
| | above the Dismiss Bar 403 to |
| | visually separate them from |
| | the rest of the menu. |
| | The right softkey again says |
| | “Select”, since there |
| | is a menu item available for |
| | select. |
| Up Pressed. | FIG. 4F. |
| The user presses the | The user can continue to press |
| up arrow key 221A | the Up arrow key to go right |
| to highlight the | across the Browser Bar 402. |
| previous menu item up, | Scrolling Down will move the |
| which is the next | cursor left across the bar and |
| icon to the right in the | back down the list of items, |
| Browser icon bar | starting with the Dismiss |
| | Bar. The icons in the Browser |
| | Bar 402 will scroll left and |
| | right if there are more |
| | icons/options than can be |
| | displayed within menu 401 |
| | at one time. |

Hence, this menu feature improves browser usability while packing more features into a small screen in a device with a limited keyboard, i.e., one without a direct pointing device such as a mouse, and without adding a dedicated key. The operation of the menu is also easily discoverable by the user. The user sees the Dismiss Bar 403 and the Dismiss softkey at the bottom of the display and intuitively knows it is a menu dismiss option. Further, it is natural for the user to scroll up to the browser-oriented icons or down to the application-oriented text, and it is easy for the user to recall how the menu operates. The use of icons to represent browser options and text to represent application options allows the user to easily distinguish between the two types of options.

II. Pop-Up Browser Menu

With a browser executing on a wireless device, often not all desired functions can be easily mapped to specific keys on the device. The browser of mobile device 100 may provide a menu of browser features, a Browser Menu, that is made available from a single key. The Browser Menu is a collection of browser features that generally are used when the user is browsing any web site. For example, the Browser Menu includes features such as bookmarking the current page; jumping to the Home page; viewing the Uniform Resource Locator (URL) of the page the user is visiting; or exiting the browser to make a phone call. Generally, all of these features are used wherever the user is browsing, and a mobile device keypad either does not have enough keys to dedicate to each feature, or it would be non-intuitive to assign these functions to the existing keys.

To solve this problem, the Browser Menu is typically activated by one keystroke or a set of keystrokes. Consequently, only one key is needed on the device to access all of these features. However, some Browser Menu features are rarely-needed features that nevertheless must exist. For example, the user may choose to “Bookmark” any site they browse to, but the user will only use this feature one time for each site he wants to remember. Thus, the “Bookmark” feature should be made available for all cards, but the user will rarely need it. This is the nature of virtually all of the usual Browser Menu commands. Features that are used more often need not appear in the Browser Menu, because they require dedicated keys (such as Up arrow, Down arrow, “Select,” and “Back”). “Back,” for example is usually assigned to the “CLR,” “END,” or a dedicated softkey and does not require a menu item in the Browser Menu.

One problem that has evolved, therefore, is related to how the Browser Menu is assigned to a key on the mobile device. Most mobile telephones, for example, have too few keys available to accommodate a dedicated key to the Browser Menu. Phones with extra keys are rare, as extra keys make the phone bulkier, and thus, less popular. Hence, it is difficult to find a key to assign to the Browser Menu, and since it is not used often, there is little justification for assigning it to a prominent key.

Combining an often-used feature with the Browser Menu causes the user to have to go through multiple keystrokes to select the popular item. For example, if “Back” is placed on the Browser Menu so that a key can be used for both “Back” and the Browser Menu, the user must first hit the key to bring up the Browser Menu and then hit the Select key to select the “Back” function. This approach makes the very often used “Back” function require two keystrokes, causing tedium for the user.

Many phones hide the Browser Menu under a “long-press” of a key (e.g., long-press of the “#” key). There are at least two problems with this approach. First, on phones where it is hidden on a long-press of an already rarely-used key (e.g., “*” or the user may never discover this menu and therefore may be penalized by not having access to valuable features like “Home,” “Exit,” or “Bookmarks.” On devices where the Browser Menu is under a long press of a more frequently used key, such as a long press of a softkey, the user may accidentally stumble into the Browser Menu when the key is unintentionally pressed too long. In this situation, the user tends to become confused and not understand that the Browser Menu is a separate menu and not a menu provided by the web site he is visiting.

Some browsers make a soft key available for this menu. In this implementation, they commonly use the word “Options” to lead to this menu. To accommodate for the need for more programmable softkeys, such devices have the programmable softkeys in the Browser Menu (under “Options”) along with the Browser Menu command. The problem with this approach is that most of the time, the user does not need the Browser Menu, but the programmable softkeys, which are much more relevant and used more often, are now an extra keystroke away and are not visibly labeled on the web page on which they operate. For example, when viewing an email message, the options to Delete and Reply may be in the Options menu when they could be available on a softkey label where the user wants it while he is reading email. Good usability design would dictate that this key not be dedicated to such an underused feature.

Another proposed solution has been to put Browser Menu options on a scrolling softkey. This approach allows the user to scroll to the right and select additional softkeys that are not visible initially. This is a solution which works well on phones that have four-way arrow keys. Scrolling softkeys does not work with most mobile devices, however, as most mobile devices only support up and down scrolling, which must be used for menu selection instead of softkey selection.

The foregoing problems can be solved by a three-part approach. First, a new visualization for the Browser Menu is used, such that the Browser Menu is a pop-up menu, rather than rendered to appear like another card or web site. This approach gives a visual indication to the user that the menu is different. Second, by displaying the Browser Menu access point in the title bar of the web site, the Browser Menu can be accessed from any card. The first time the user scrolls up on a card, the Browser Menu is highlighted. Third, a visual indicator is added in the Title Bar, so that the user can see the that there is something up there that he can try to interact with. The resulting Browser Menu is accessible from any card of any web site without requiring it to be mapped to a dedicated key. In a given device, this feature may be complementary to that of the combined browser-application menu described above.

Underlying this approach is the realization that the Browser Menu features do not require immediate accessibility from any position on a card. Thus, if the user scrolls down 10 times, they will have to scroll back up 11 times to select the Browser Menu. This is acceptable, since the Browser Menu commands are rarely needed for a card. However, on arrival to any card, the Browser Menu is only a few keystrokes away (usually an Up scroll followed by a Select of a softkey or action key).

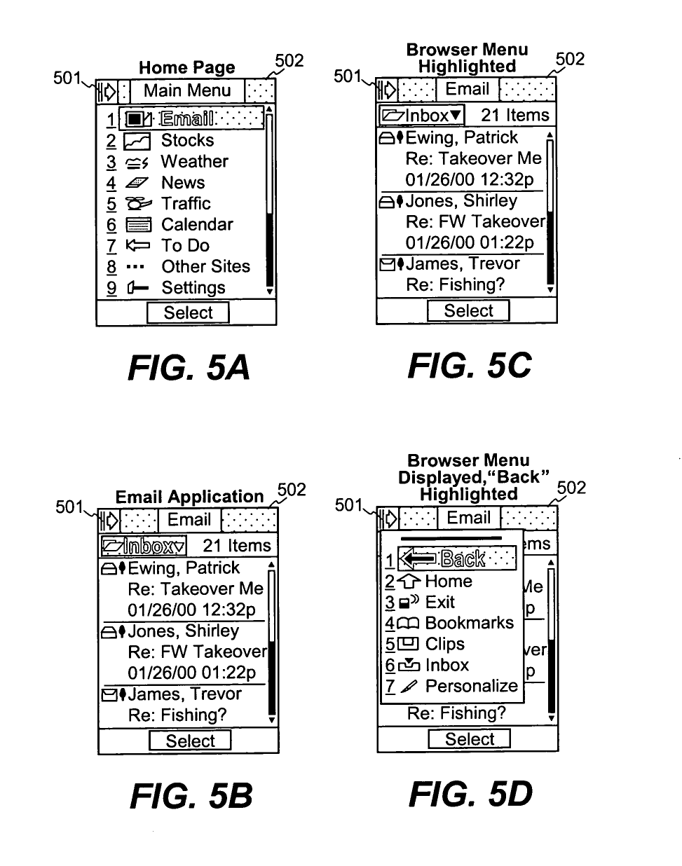

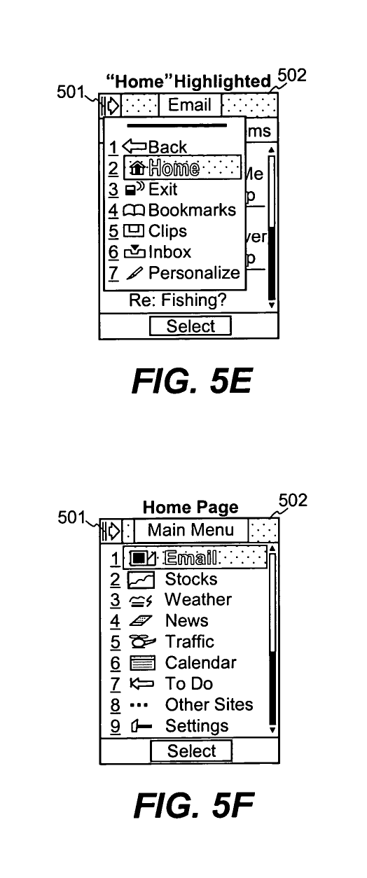

FIGS. 5A through 5F show a series of screens for an example that demonstrates how the Browser Menu operates, as described in Table 2. In this example a user traverses from a Home Page or startup card, into an application (Email is this example), and then use the Browser Menu to return to Home. A “P” icon (e.g., the logo of Phone.com, a predecessor of Openwave Systems) is used in the title bar in these examples to denote the Browser Menu.

TABLE 2
Pop-Up Browser Menu

| Action | Result/Explanation |
|---|---|
| Start. | The first menu item, |
| Begin in the Home Page | “Email,” is |
| of a browser, as | highlighted. The user can |
| shown in FIG. 5A, | use the “Select” |
| where the user can | key (which may be Enter |
| select to access any | key 220 or a softkey) to |
| of multiple web sites. | select any menu item. The |
| | user can use the Up and |
| | Down arrow keys 221A and |
| | 221B to highlight a |
| | different menu item for |
| | selection. |
| | Notice the “P” icon |
| | 501 in the title bar 501. |
| | This icon represents the |
| | browser menu. For this example, |
| | it will not be selected |
| | until after proceeding into |
| | the Email application. |
| Select Pressed. | FIG. 5B. |
| The Select key is | The title-bar 502 is now |
| pressed on the previous | labeled “Email,” |
| screen to go to the | but the “P” icon 501 |
| Email web site. | remains. This indicates to the |
| | user that the Browser Menu is |
| | always available on any web site. |
| Up Pressed. | FIG. 5C. |
| The user presses the | The “P” icon 501 is |
| Up arrow key 221A | now inverted (white on black) |
| to highlight the “P” | to show that it is the currently |
| icon 501 representing | highlighted area of the screen. |
| the Browser Menu. | Note: The Browser Menu does |
| | not automatically pop up when |
| | the “P” icon 501 is |
| | selected, since the user may have |
| | meant to scroll to the top |
| | control or menu item on the screen, |
| | and the down arrow key 221B needs |
| | to be available for scrolling back |
| | down (and not for scrolling |
| | though menu items). The user must |
| | “Select” the browser |
| | menu with the Select Key to bring |
| | up the menu. |
| | Variations can be implemented, |
| | in which the browser menu does |
| | automatically pop up, but where |
| | an additional up-arrow keystroke |
| | will dismiss the menu. |
| Select Pressed. | FIG. 5D. |
| The user presses the | The Browser Menu is now displayed. |
| Select key to pop up | The first item in the Browser |
| the Browser Menu. | Menu is automatically highlighted |
| | to allow it to be accessed quickly. |
| | In this example, the first item in |
| | the menu is the Dismiss Bar |
| | for dismissing the browser menu. |
| | The user can now scroll up or down to |
| | highlight the menu item he wishes to |
| | choose. |
| Down Pressed. | FIG. 5E. |
| The user presses the | The “Home” item is now |
| Down arrow key 221B one | highlighted for selection. The |
| time to highlight “Home.” | user can now select Home to cause |
| | the browser to go to the Home |
| | Page. |
| Select Pressed. | FIG. 5F. |
| The user presses the | The browser returns to the Home |
| Select key to select | Page, with the first item, |
| “Home.” | “Email”, highlighted. |

Hence, a Browser Menu is added to the browser's features without requiring any dedicated keys or new key assignments. The existing Up arrow key 221A, Down arrow key 221B, and Select key 220 are sufficient to use this feature. This feature is easily discoverable by the user over normal usage of the browser. The Browser Menu is easily distinguishable from other menus. The user will discover it either by accident or by noticing, from the icon in the title bar, that there is something above the displayed content that may be selectable. The user may find this feature by accident the first time he scrolls up to highlight the first item in a card and he accidentally scrolls one time too many, causing the “P” icon 501 in the title bar 502 to become highlighted. The highlighting of the “P” icon 501 in the title bar 502 is the visual feedback that makes this discoverable. In addition, this feature is easy for a user to remember. As soon as the user discovers the Browser Menu in the title-bar 502, he will immediately and continually associate the “P” icon 501 in the title-bar 502 as a place to go for extra features. Also, the “P” icon 501 is unobtrusive and does not take away a valuable key from the user that could be used for more important features.

III. Auto-Jump

Browsers on most mobile devices must be operated in a limited navigational environment due to the fact that these devices have so few keys and no “smart” input mechanism such as a mouse or pen-input. One area of concern is any operation that requires a greater number of keystrokes than what seems reasonable to the user. One particular area where the user may feel that too many keystrokes are required is when the user wants to edit a set of fields in a form of fields. To do this the user typically must, for every field, put the field into edit mode, make the desired edits, take the field out of edit mode, and then scroll to the next field. In the case of selecting a radio button in a group of radio buttons, this may mean that the user has to scroll down past all the remaining radio buttons in the group that he did not select. Therefore, a quicker way to accomplish this goal is needed.

A solution to this problem is now described and is referred to herein as “auto-jump”. The auto-jump feature operates as follows: 1) Upon entering any screen, the up/down arrow keys 221A and 221B are used for scrolling and highlighting of controls initially. 2) After a user takes a control out of “Edit” mode (e.g., completing an edit in a text edit control), or if the user selects a simple control like a radio button or checkbox, then the next control is automatically highlighted. (A “control” is a user interface feature with which a user may interact to cause a function or enter input.) If the user selects a radio button or other similar grouping of controls that the browser can detect, then there is a jump to the next control not part of that radio button's group. In instances when the next selectable control is off the bottom of the screen, the screen may be automatically scrolled to bring that control within view, followed by selection of that control. Alternatively, the auto-jump feature may be disabled in such instances.

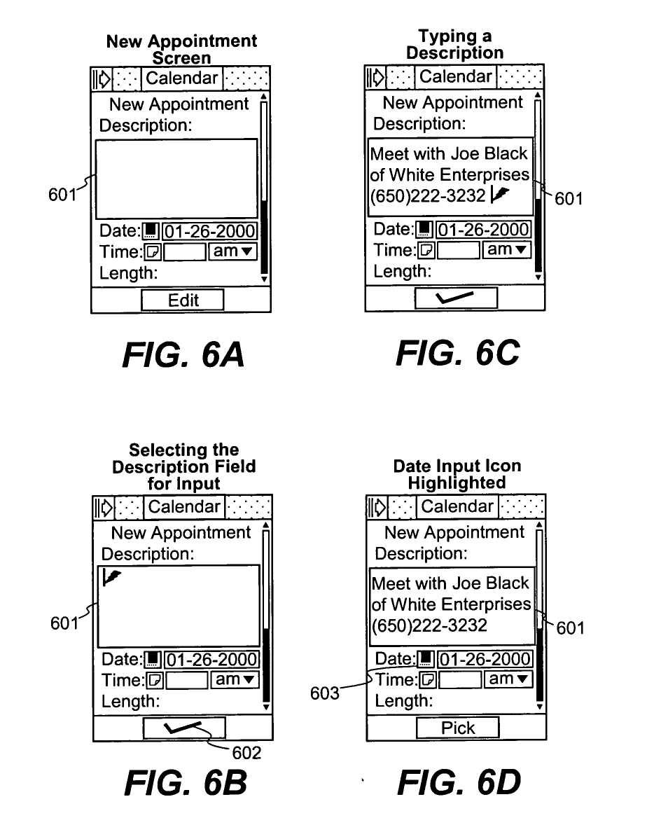

FIGS. 6A through 6D show a series of screens that demonstrate how this navigational feature operates. Table 3 describes how a user completes the editing of a text box (for entering an appointment) in conjunction with FIGS. 6A through 6D. The highlight automatically jumps to the next control, the Date input icon control.

TABLE 3
Auto-Jump -- Text Box Editing

| Action | Result/Explanation |
|---|---|
| Start -- FIG. 6A. | Using the Up/Down arrow keys |
| When entering a new | 221A and 221B (FIG. 2), the |
| appointment, the user | user can scroll to each control |
| first needs to highlight | in a screen and highlight it. |
| the Description field 601. | In this case, the user has high- |
| | lighted the Description field 601 |
| | to provide text input. |
| The user presses the | FIG. 6B. |
| Select key to put the | Now the Description field 601 has a |
| Description into “Edit” | cursor in it for text input. Also, the Select |
| mode, where the user now | softkey button changes to a checkmark |
| can type, and the arrow | symbol 602 to give the user visual |
| keys only apply to the | feedback to instruct him to press it to |
| Description field. | complete the editing. |
| User Types. | FIG. 6C. |
| The user types in a | Notice how the Description field |
| description into the | is still activated while the user |
| Description field 601. | types input into it. |
| Select Key Press. | FIG. 6D. |
| The user presses the | After ending the edit session on |
| Select key to end the | the Description field, the high- |
| editing of the Description | light does not revert to the original |
| field. | state of the first screen (i.e. |
| | highlighting the Description |
| | field and requiring a Down-Arrow |
| | to highlight the next control), but |
| | instead the highlight “jumps” |
| | automatically to the next control, |
| | in this case the Date Input Icon 603. |

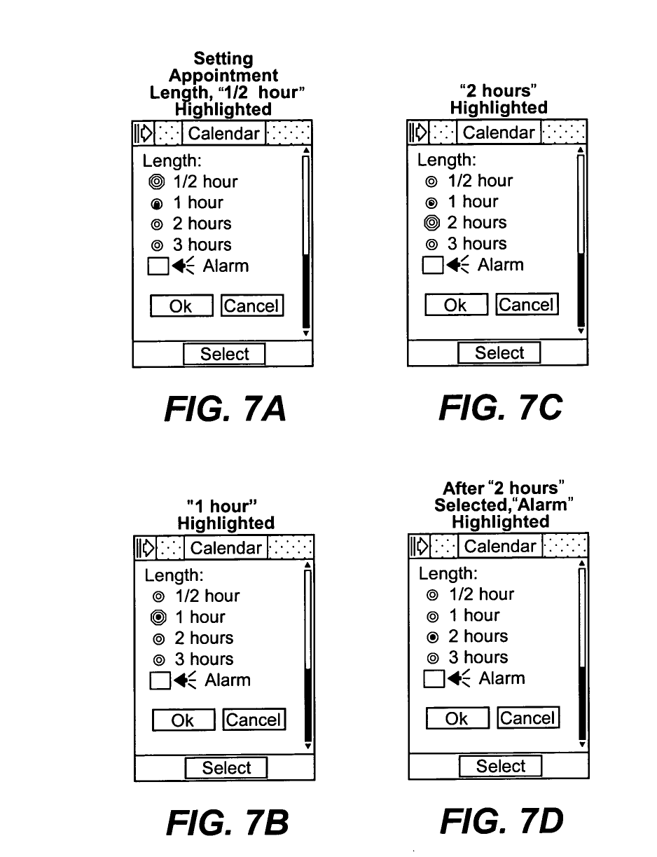

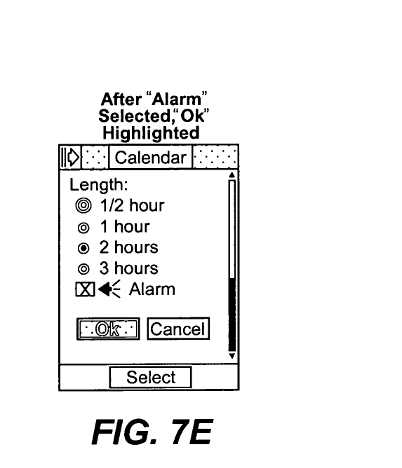

FIGS. 7A through 7E show a second example of the auto-jump feature, in which a user selects a duration of two hours for an appointment with a radio button control to automatically skip the cursor (highlighting) to the next control, the Alarm checkbox control. Afterward, if the user selects the Alarm checkbox, the cursor jumps to the Push Button. Table 4 describes the operations and effects shown in FIGS. 7A through 7E.

TABLE 4
Auto-Jump -- Radio Button Editing

| Action | Result/Explanation |
|---|---|
| Start -- FIG. 7A | The “½ hour” |
| When entering a “Length” | radio button is highlighted, |
| for a new appointment, the | but not selected. |
| user is required to select | |
| one radio button. | |
| Down Key Press | FIG. 7B. |
| The user presses the down | Now the “½ hour” |
| arrow key 221B one time | radio button is unhighlighted, |
| to select the next Length | and the “1 hour” radio |
| option. | button is highlighted instead. |
| | In addition, the “1 hour” |
| | radio button is already selected. |
| | This is because this is the default |
| | radio button for the group. |
| | Note: A variation that can |
| | be implemented is to skip |
| | selected radio buttons, since |
| | they cannot be re-selected. |
| | This may not be desirable, |
| | however, as the user may want |
| | to leave the length as 1 |
| | hour, and if it skips this |
| | radio button then the user has |
| | to scroll down two more |
| | times to get to the next control. |
| | If it is highlighted, then the |
| | user can re-select it just to |
| | take advantage of the jump out of |
| | the fields. |
| Down Key Press | FIG. 7C. |
| The user presses the down | Notice that now the “1 hour” |
| arrow key 221B one time | radio button is no longer highlighted, |
| to select the next Length | and the “2 hours” radio |
| option. | button is highlighted instead. |
| | The screen scrolls up automatically |
| | as the user presses the down-arrow |
| | key 221B to go to each next control. |
| Select Press | FIG. 7D. |
| The user presses the | Notice that the “2 hour” |
| Select key to set the | radio button is now selected. |
| appointment to 2 hours. | Also notice that the “3 |
| | hours” radio button is never |
| | highlighted. The highlight jumps |
| | out of the group of radio |
| | buttons and straight to the “Alarm” |
| | checkbox. From here the user |
| | can either down-arrow to the “Ok” |
| | button, or select the Alarm, which |
| | is shown next. |
| Select Press | FIG. 7E. |
| The user presses the | Notice that the “Alarm” checkbox |
| Select key to set the | is now checked, and the cursor |
| Alarm for the appointment. | automatically jumped to the “Ok” key |
| | for the next input (because it is the |
| | next control on the screen). |

Thus, a key advantage of the auto-jump feature is saving the user an unnecessary keystroke for every field he edits in a form. These keystrokes can become tedious to the user for large forms.

IV. Control Context Sensitive Menu

Users of mobile devices often find it very difficult to enter data when doing so requires input of mixed text, numbers, and/or symbols. Users sometimes cannot determine how to change the text input mode (or they do not even know or surmise that they should). It is expected that similar complications and usability issues will occur for other controls in the future as the controls become more sophisticated. It is also expected that mobile phone keypads will remain fairly constrained in terms of navigational options in the future. What is needed is a good user interface metaphor for providing context sensitive accelerators and helpers while editing data presented in a user interface control such as a text edit box, pop-up menu, table, etc.

In certain mobile device browsers, the solution for changing the mode for text editing is to overtake (reassign) the second softkey and require the user to press the softkey to switch modes. It has been found that this approach is difficult for users to discover and use. This is difficult for users, because in all other applications, the second softkey typically causes navigation to other screens, not changing the mode on the existing screen. Changing the meaning of this softkey only for one type of screen causes users to be reluctant to use the softkey. This is especially true during text input when users may fear losing data already entered.

Some mobile phones have a hidden key combination to change the text input mode (if they support mode changes). This is usually done, for example, by pressing a key or pressing and holding a key. One such device allows the user to change mode by pressing the star (“*”) key. This approach is not intuitive, however, and is not always an available option for other phones. Another mobile phone allows input mode changes by pressing and holding the number key the user is using to type with. This approach also is not easily discoverable, intuitive, or memorable. Other phones change text input mode by putting all of the characters possible on each key. This requires the user to type many more keystrokes than if they could simply switch modes. For example, if the user tries to type “Steve”, he will have to press “PQRS” for the “S”, then “TUVt” for the “t”, “DEFde” for the “e”, etc.

One complicated control is the smart text-input control, such as that provided by Tegic. Most implementations of smart text input require hard-coded keys for their extra behavior, and have not found another way to present their options to the user. Complex controls on PCs do not have this problem, since most of the problem arises from the small number of navigational and data input keys. PCs handle the text input control easily with the rich input metaphor provided by a full-size keyboard and a mouse. Other complicated controls, such as Spin Controls, Tables and Pop-up menus, are easily and efficiently navigated with a mouse. There is no need to optimize or provide helper menus or functions for those controls in such an environment.

To deal with increasingly complex controls, such as text edit boxes, tables, pop-up menus, and spin controls on a limited navigational device (e.g., one without a direct pointing device), a navigational mechanism is described herein which provides control context sensitive pop-up menus whenever a complex control is activated for editing its data. It is assumed, for purposes of describing this feature, that the mobile device supports the following keys: Up Arrow, Down Arrow, Primary Softkey, Secondary Softkey, and Back/Clear key. To allow for context sensitive browsers with this limited navigational keyset, a GUI is provided in which the navigational functionality of the arrow keys and softkeys is split between two states: navigating the controls while scrolling the screen, and editing a control.

This feature operates as follows:

1) Upon entering any screen, the up/down arrow keys 221A and 221B are used for scrolling and highlighting of controls only:

a) The arrow keys cause scrolling whenever the user has reached the top or bottom of the screen and the screen must scroll to show more data, whether it requires highlighting or not.

b) The arrow keys cause highlighting whenever there is a highlightable control such as a radio button, text edit box, or push button that is visible or becomes visible to the right or below the currently highlighted control. Thus, the controls all are highlighted first, then the screen scrolls. If when the screen scrolls, a new control becomes visible, the control is highlighted.

2) When the user wants to operate a control, the user must press the Enter key or primary softkey.

a) This act will put certain controls into edit mode, where the user can change its value (such as editing text, selecting a pop-up menu item, or spinning a spin-control). If the control goes into edit mode, the primary softkey is used to take it back out of Edit mode (i.e. complete the editing session), and the secondary softkey is used to represent a control context sensitive menu.

b) On other controls the primary softkey will simply execute the control's default action (such as going to a menu, link, or push-button's destination, or toggling a checkbox).

Thus, case 2a above is the solution to solving the need for a helper menu for operating on a complex control on a navigational control-restrained device.

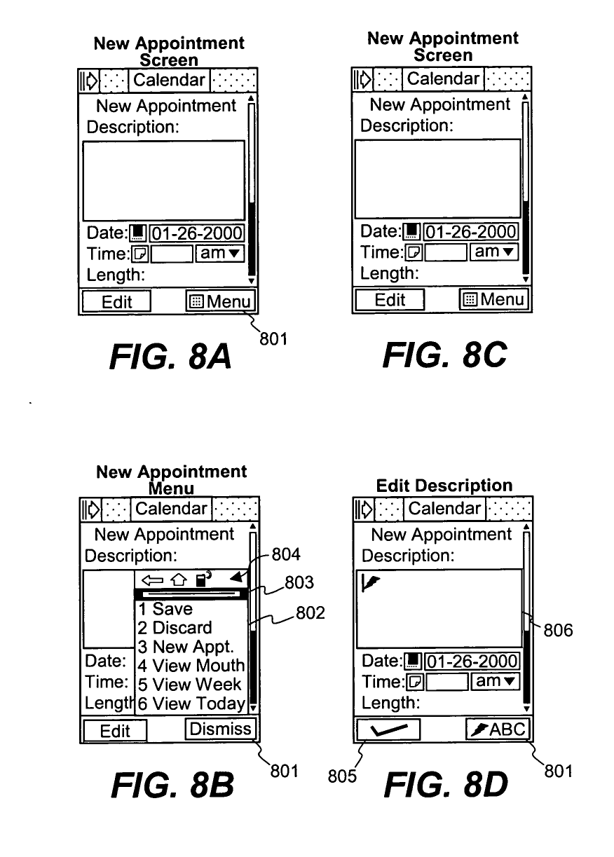

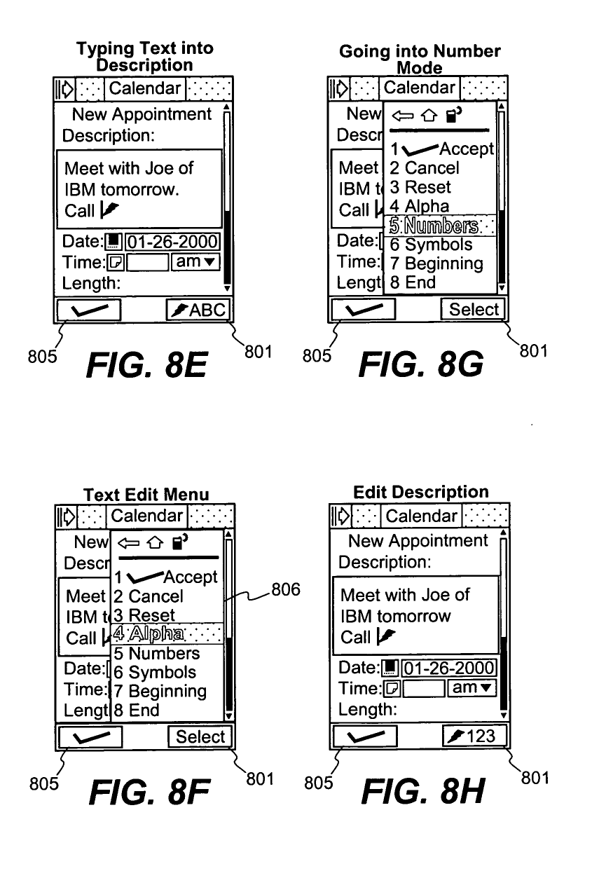

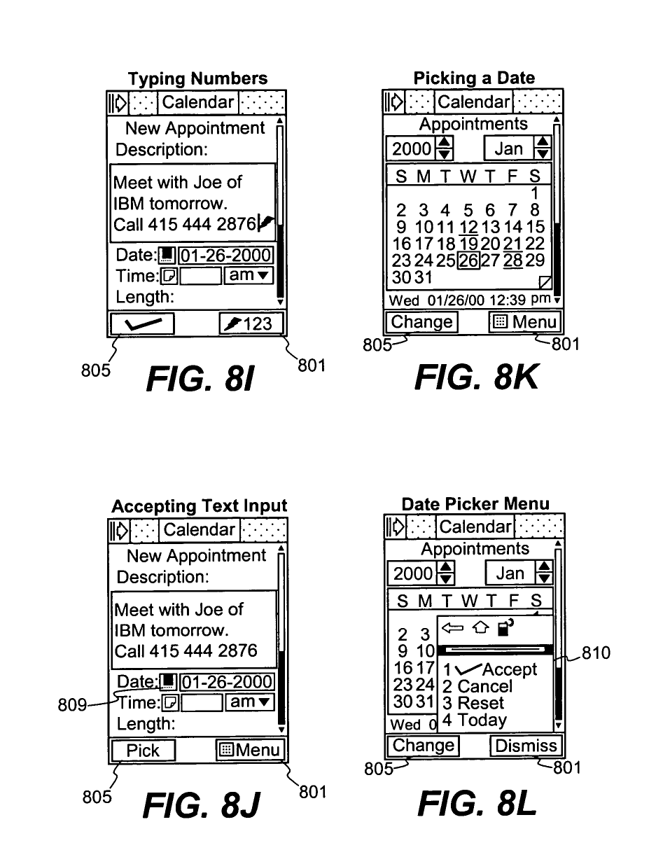

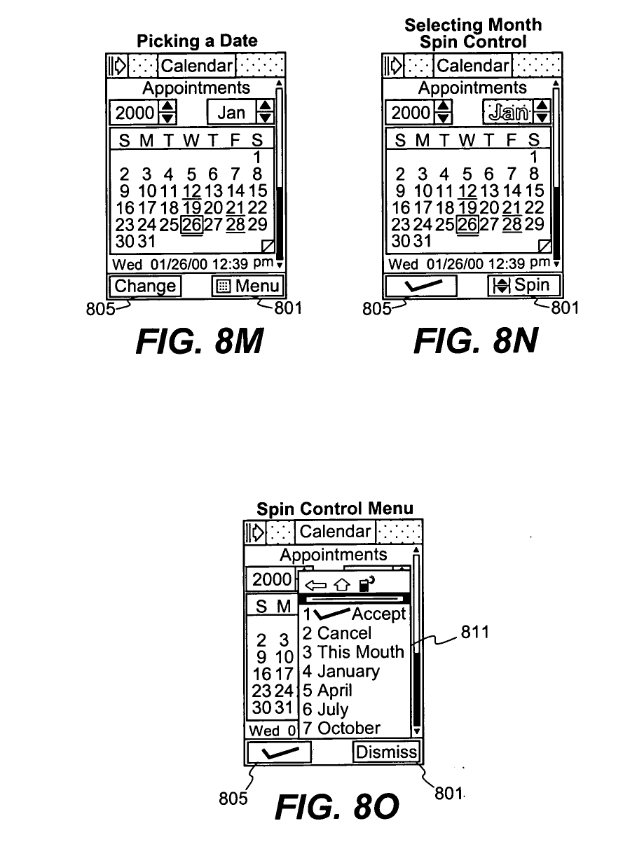

FIGS. 8A through 80 show an example of how the control context sensitive menu feature operates, and particularly, how the second softkey can be used to represent a context sensitive menu depending on whether a control is selected. Here, adding an appointment in a calendar application is used as an example. Table 5 describes the operations and effects shown in FIGS. 8A through 8O.

TABLE 5
Control Context Sensitive Menu

| Action | Result/Explanation |
|---|---|
| Start -- FIG. 8 A. | The second softkey (on the bottom |
| Begin in the “New | right of the screen) is labeled |
| Appointment” screen. | “Menu.” It represents the |
| | application menu programmed by the |
| | developer to appear whenever the user |
| | is not editing within a control. |
| Softkey 2 Pressed. | FIG. 8B. |
| The user presses the key | Notice the Application sensitive |
| associated with the second | menu 802. This is programmed by |
| softkey 801, usually located | the developer, and has application |
| below the “Menu” | wide options, like “View Month,” |
| label button on the | “View Week,”and “View |
| right. | Today.” It also has options |
| | that applies specifically to this |
| | appointment the user is editing, |
| | such as “Save,” “Discard,” |
| | and “New Appointment,” which |
| | starts over with a new appointment. |
| | In addition, the second softkey |
| | 801 changed to “Dismiss” when |
| | this pop-up menu appeared. This is |
| | because the “Dismiss Bar” 803 |
| | is selected. |
| | The icons 804 at the top of the |
| | menu 802 are selectable to perform |
| | browser functions, such as moving |
| | back a screen, going to the home |
| | card, and exiting the browser to |
| | make a phone call. |
| Softkey 2 Pressed. | FIG. 8C. |
| The user presses the second | The user is back to the first |
| softkey 801 (“Dismiss”) | screen again, as the user chose |
| to dismiss the menu without | not to select any of the menu |
| selecting any items. | options. |
| | At this point, the user can |
| | scroll down to select other |
| | controls; select the first |
| | softkey to “Edit” the |
| | “Description,” or |
| | reselect “Menu” to view |
| | or perform application menu |
| | options. |
| Softkey 1 Pressed. | FIG. 8D. |
| The user presses the first | The Description control 806 is |
| softkey (on the left) 805 | now in Edit mode with the cursor |
| to “Edit” the | drawn to show it is ready for text |
| “Description” text. | input. Also, the “Edit” |
| | softkey 805 is now a “Checkmark”. |
| | The reason for this is to show that |
| | the control must be taken out of |
| | Edit mode to begin selecting other |
| | controls again. |
| | In addition, the second softkey |
| | 801 now says “ABC” to show |
| | it is in text input mode. This |
| | softkey now represents a “Text |
| | Edit” menu, accessible to help |
| | the user in the entry of text. The |
| | previous application menu is no |
| | longer accessible until the user |
| | takes the control out of Text |
| | Edit mode. |
| Typing Info | FIG. 8E. |
| The user types in the | Nothing changes other than that the |
| description of the | user's text is shown in the display. |
| meeting. | The user now wants to enter a phone |
| | number, and has to transition to |
| | number input mode to do this. |
| Softkey 2 Pressed. | FIG. 8F. |
| The user presses the | The menu 806 activated by the second |
| second softkey 801 | softkey 801 is now a context sensitive |
| to view the Text Edit | menu related to text input. It allows |
| Menu. | the user to accept the text, cancel the |
| | input, or return the text to its original |
| | state before being edited. It also allows |
| | the user to change from Alphabetic mode |
| | to Number mode or Symbol mode. Finally, |
| | the menu offers help to the user to jump |
| | to the beginning or end of the text. |
| | The menu 806 comes up with “Alpha” |
| | highlighted as the mode is the most |
| | common thing a user changes. |
| Down Pressed. | FIG. 8G. |
| The user presses the | The user can now switch into number |
| down arrow to high- | entry mode. |
| light the “Numbers” | |
| menu item. | |
| Softkey 2 Pressed. | FIG. 8H. |
| The user presses the | The second softkey label is now “1 2 3”, |
| second softkey 801 | which shows the user that the device is in |
| to view accept input | number mode. |
| into the Text Edit | |
| menu. | |
| Numbers typed. | |
| The user types in the | The numbers appear on the screen. If this |
| phone number. | is a phone, then using number mode is |
| | the fastest way to enter numbers. |
| Softkey 1 Pressed. | FIG. 8J. |
| The user presses the | The input is accepted and the highlight |
| first softkey 805 to | jumps to the next control, which is the |
| exit Text Edit mode. | Date Picker control 809. |
| | In addition, the second softkey has |
| | reverted to representing the New |
| | Appointment application menu again. |
| Softkey 1 Pressed. | |
| The user presses the | The Date Picker is displayed. This is just |
| first softkey 805 to | another web site or application on the |
| pick a date. | device. It has its own menu on the |
| | second softkey as well. |
| Softkey 2 Pressed. | FIG. 8L. |
| The user presses the second | The displayed menu 810 applies only to |
| softkey 801 to view the | picking dates. The user can accept the |
| Date Picker menu. | currently selected date, cancel date |
| | picking mode and return to the last |
| | screen, reset the date to the date it had on |
| | entry, or select today's date. |
| Softkey 2 Pressed. | FIG. 8M. |
| The user presses the | The user returns to the mode he was in |
| second softkey 801 | before viewing the Date Picker menu. |
| to dismiss the Date | |
| Picker menu. | |
| Softkey 1 Pressed. | FIG. 8N. |
| The user presses the | The control goes into edit mode, and the |
| first softkey 805 to | second softkey 801 is dynamically |
| change the month using | reassigned to represent a context |
| the Month Spin | sensitive menu for Spin controls. |
| Control. | |
| Softkey 2 Pressed. | FIG. 8O. |
| The user presses the | The Spin control menu 811 has items that |
| second softkey 801 | help in changing the spin control's value. |
| to view the Spin | Notice how special items like “This |
| Control menu. | Month” or a month every quarter are |
| | listed for faster access. |

Hence, the second softkey is overtaken (reassigned) when editing a control. The resulting control context sensitive menu can be implemented in a device that has no direct pointing device (e.g., in a two-arrow device), without requiring any dedicated keys for this function. The menu is easily discoverable by the user through normal usage of the browser. A user will discover it either by accident or by noticing that the icon (and potentially the label) in the second softkey has changed. Further, this feature is easily remembered. As soon as the user discovers the control menu, he will remember it and use it in the future when he needs it. In addition, this feature is not intimidating for users to try. The second softkey can be used as a menu in all applications, so the user will not expect it to take them to another screen. The user will try the feature without worrying about losing data. Moreover, this feature provides unique and different visual feedback to the user. A different icon will be drawn in this menu depending on the data input mode.

V. Two Arrow Key Table Navigation and Calendar Date Selection

Tables of information are a very popular feature in software products, as they help the developer both to lay out the data for easy viewing as well as to make it easier for the user to view and input data. On a small mobile device, there is also a need for tables, but the user wants to be able to navigate them with as few keystrokes as possible. As noted above, many mobile devices only support up and down arrow keys, and most also have a select key that can be used with the up and down arrows to select an item. However, tables generally require four-directional pointing control (i.e., left, right, up and down) for the most effective navigation.

Certain mobile devices allow a user to navigate tables by requiring the user to press the down arrow key once to advance to each cell in the table, moving through each cell in each row before going to the next row. The up arrow key reverses the direction. Although this may be intuitive for the user, it is very tedious if the table is large. There is a need, therefore, for an efficient way to navigate a table on a mobile device with only two opposing arrow keys.

Described herein is a feature for more efficient table navigation in a two-arrow mobile device. The user navigates a table by selecting rows first, with each row highlighted as the user proceeds down the table (and reversing the direction with the up-arrow). After highlighting the row on which the user wants to operate, the user uses the Select (or “Enter”) key to select that row. After a row is selected, the up and down arrow keys 221A and 221B, respectively, are used to navigate the cells in that row. Once the desired cell is highlighted, the user can use the Select key again to select that cell. This approach enables the user to move more quickly when pinpointing a cell of a large table.

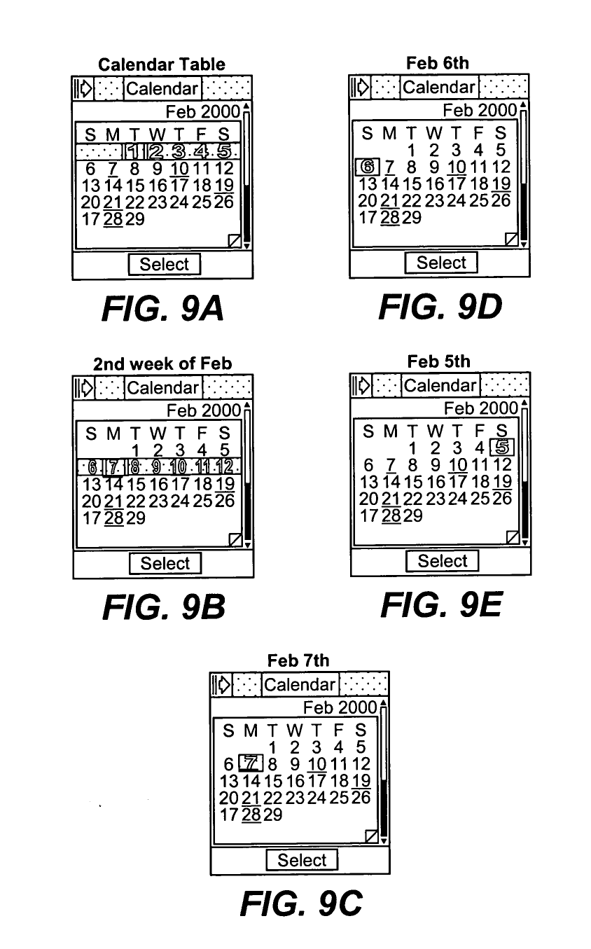

FIGS. 9A through 9E show a series of screens for an example that demonstrate how this table navigation feature works. Table 6 describes the operations and effects shown in FIGS. 9A through 9E. In this example, a calendar has been implemented as a table of row and cells with dates. Calendars are a very popular feature to display to users on mobile devices when the user needs to select a date. A calendar is graphical and conveys more information to the user than a simple text input box. First, the user will highlight the row he wants, and then he will select that row to edit the cells.

TABLE 6
Two Arrow Key Table Navigation

| Action | Result/Explanation |
|---|---|
| Start -- FIG. 9A. | On entry, the first row of the table is |
| The calendar is a | highlighted as this contains the current |
| table of rows and cells. | date. Other tables may come up with any |
| | logical row selected, or the first row |
| | selected if that makes the most sense. |
| | The user can now highlight a different |
| | row by using the Up and Down arrow |
| | keys 221A and 221B. |
| Down Key Press. | FIG. 9B. |
| The Down arrow key is | The next row is selected. In this example |
| pressed once to | the calendar also pre-selected the first |
| highlight the next row. | weekday cell (February 7^{th}), but in other |
| | tables the first cell or any logical cell may |
| | become selected automatically when the |
| | user scrolls up or down. |
| Select Key Press. | FIG. 9C. |
| The Select key is | The last selected cell is highlighted, in |
| pressed once to enter | this case Feb. 7^{th}. |
| cell entry mode. | Now the Up and Down arrow keys move |
| | within the cells. |
| Up Key Press. | FIG. 9D. |
| The Up arrow key is | The previous day, Feb. 6^{th}, is highlighted. |
| pressed once to | |
| highlight the previous | |
| cell. | |
| Up Key Press. | FIG. 9E. |
| The Up arrow key is | Since there are no more cells to the left of |
| pressed once to | the highlighted cell, the last cell of the |
| highlight the previous | previous row is selected, Feb. 5^{th}. |
| cell. | When the user is done navigating, he can |
| | press the Select key to move on to other |
| | actions. |

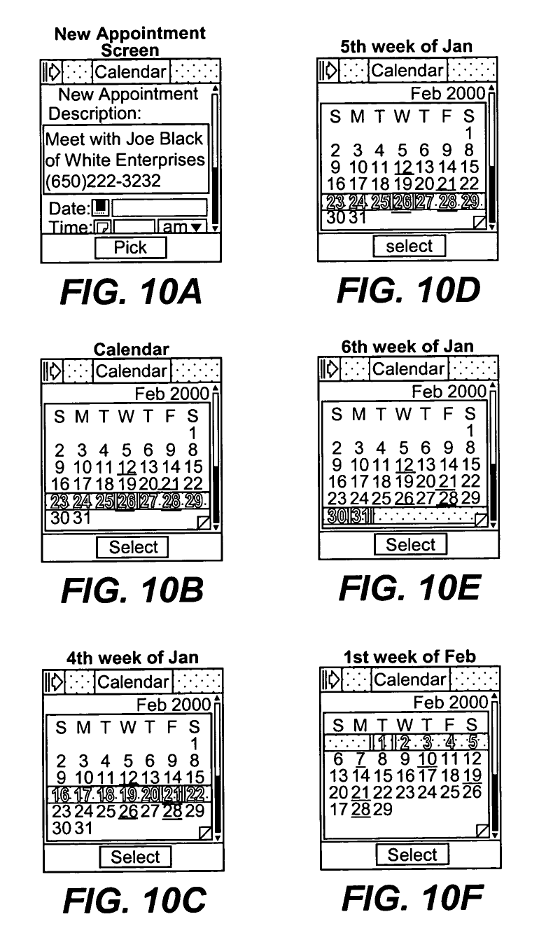

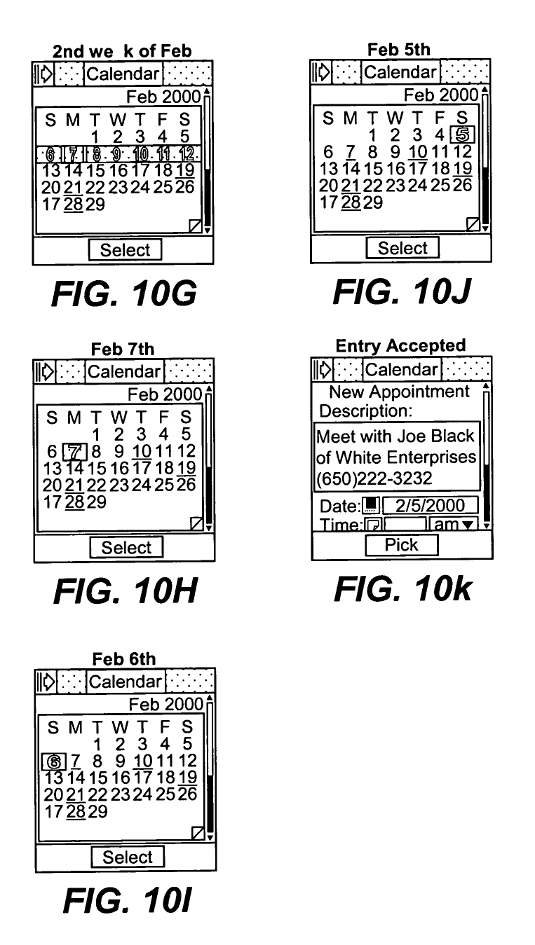

FIGS. 10A through 10K show a series of screens for another example of the operation of the calendar (table) navigation, with smart selection of dates. Table 7 describes the operations and effects shown in FIGS. 10A through 10K. The smart selection comprises moving the cursor automatically to the closest weekday when the user is in row-selection mode (i.e. when the user is selecting a week) and navigates to a new week or month. It may be preferable to start on the current day or the day the user is editing.

TABLE 7
Two Arrow Key Calendar Navigation
with Smart Selection of Dates

| Action | Result/Explanation |
|---|---|
| Start -- FIG. 10A. | The “Date” icon is highlighted. |
| When entering a new | The user can either go to the next |
| appointment, the | field and type in a date, or he can use |
| user needs to enter a date. | a calendar to select the date. |
| Action Key Press. | FIG. 10B. |
| The Action Key is pressed | On entry, the fifth week is highlighted as |
| to select “Pick” | this contains the (example) current date. |
| from the previous screen. | The currently selected day has a box |
| | around it (the 26^{th} of January). |
| | The user can now highlight a different |
| | week by using the Up and Down arrow |
| | keys 221A and 221B. |
| Up Key Press. | FIG. 10C. |
| The Up arrow key is pressed | The last weekday is selected in the 4^{th} |
| once to highlight the | week of January. That is because in the |
| previous week. | selected week Friday the 21^{st} is the |
| | closest weekday to January 26^{th}. |
| Down Key Press. | FIG. 10D. |
| The Down arrow key is | The current date is remembered and |
| pressed once to | selected again. This makes it easy for |
| re-highlight the current | the user to return to the date they |
| week. | started with. |
| Down Key Press. | FIG. 10E. |
| The Down arrow key is | The first weekday is selected in the sixth |
| pressed once to | week of January. That is because |
| highlight the next week. | Monday the 31^{st} is the closest weekday to |
| | January 26^{th}, the previously selected date. |
| Down Key Press. | FIG. 10F. |
| The Down arrow key is | The first weekday is selected in the first |
| pressed once to | week of Feb. That is because Monday the |
| highlight the next week. | 1^{st} is the closest weekday to Jan 26^{th}, the |
| | previously selected date. |
| Down Key Press. | FIG. 10G. |
| The Down arrow key is | The first weekday is selected in the |
| pressed once to | second week of February. That is because |
| highlight the next week. | Monday February 7^{th} is the closest |
| | weekday to January 26^{th}, the previously |
| | selected date. |
| Select Key Press. | FIG. 10H. |
| The Select key is | The last selected date is highlighted, in |
| pressed once to enter | this case February 7^{th}. |
| day entry mode. | Now the Up and Down arrow keys move |
| | within the cells. |
| Up Key Press. | FIG. 10I. |
| The Up arrow key is | The previous day, February 6^{th} is |
| pressed once to | highlighted. |
| highlight the previous | |
| day. | |
| Up Key Press. | FIG. 10J. |
| The Up arrow key is | Since there are no more cells to the left of |
| pressed once to | the highlighted date, the last day of the |
| highlight the previous | previous row is selected, February 5^{th}. |
| day. | |
| Select Key Press. | FIG. 10K. |
| The Select key is | The highlighted date from the last screen |
| pressed to accept the | is inserted into the application. |
| highlighted date. | |

VI. Non-Scrolling Headers

Wireless phone browsers currently support rendering a single page of markup language content using the full screen capabilities of the device. Often such pages will have a static title, but no support is provided for the popular and useful “frames” feature found on PC browsers. This shortcoming prevents the developer (content provider) from providing and guaranteeing that certain important data is displayed on the screen while the user is accessing the developer's site, such as the developer's logo, an advertisement, or other features that are relevant to the page the user is on.

The problem is that frames are difficult to provide on a user interface that is limited to up and down arrows and selection. If the device has a direct pointing device such as a mouse, the user can easily switch frames using the pointing device, as done on a PC. Without such a pointing device, however, it is very hard to determine where the user is focused on the device.

This problem can be solved by allowing the developer to define a header or top-level frame for the mobile device. This solution will also work for a footer frame and, given enough screen space, for side frames as well. The frame works by starting the user's navigation on one of any highlightable controls within the header frame. The user can operate on these controls first, and then when the user scrolls down past the last control within the header frame, the first control in the body of the card is selected. If the user scrolls past the visible area on the screen for the body, then only the body scrolls and the header remains fixed at the top of the screen. If the user scrolls up, then the content scrolls back down until there is no more content to scroll. At this point, the highlight jumps up to the header again, and works its way through the header controls as the user presses the up or down arrow keys.

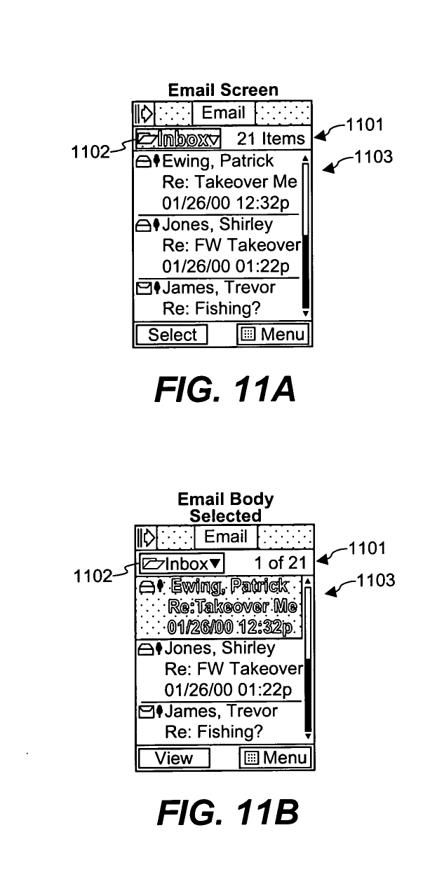

FIGS. 11A and 11B show a pair of screens for an example of how the non-scrollable header feature operates. Table 8 describes the operations and effects shown in FIGS. 11A and 11B. In this example, the user enters an electronic mail (“Email”) application and moves from the header to the body.

TABLE 8
Non-Scrolling Headers

| Action | Result/Explanation |
|---|---|
| Start -- FIG. 11A. | The header 1101 (below the title bar |
| Begin in the “Email” | labeled “Email”) has a highlight |
| screen. | on the control that is actionable in it, |
| | i.e., the “Inbox” pop-up control |
| | 1102 is highlighted. If there is nothing in |
| | the header 1101 to highlight, then the first |
| | highlightable item in the body 1103 is |
| | highlighted. In this example, the header |
| | consists of the “Inbox” menu and label “21 |
| | Items”. The body 1103 is the region |
| | below the header 1101, as a list of email |
| | messages, with the scrollbar on its right. |
| Down pressed. | FIG. 11B. |
| The user presses the | The first email message is highlighted. |
| down arrow key to | The user can now scroll down through all |
| select the next item. | of the messages by repeatedly pressing |
| | the down arrow. If the user scrolls down |
| | by pressing the down arrow repeatedly |
| | until he passes the viewable area, only |
| | the email messages (or body portion 1103 |
| | of the screen) will scroll. When the user |
| | scrolls up with the up-arrow, he must |
| | scroll all the way back to the first message |
| | before the highlight will jump back up |
| | into an actionable control in the header |
| | 1101. |

Hence, this technique provides a way of implementing frames in a two-arrow mobile device, while also meeting good user interface design criteria. This technique does not require a dedicated key to switch between the header and the body or a direct pointing device (e.g., a mouse). The technique is easily discoverable by the user through normal use of the browser. A user will arrive at screens with the highlighting positioned in the header, and will intuitively scroll down off of the header and into the body region. Once the user reaches the viewable body, he will either expect the whole screen to scroll, or he will notice the scroll bar showing that the header will not scroll. Either way, the user will quickly (and with feedback) discover that the header is not scrolling. Upon returning to the top item in the body after having scrolled down, the user will either intuitively know that he will continue scrolling through the body, or he may expect to jump to the header. Either way, the fact that the body scrolls quickly indicates to the user that he must continue to press the up-arrow until he has scrolled to the top of the body.

VII. Text Input Control

Text input controls are form elements that can be used in a mobile device for data input in the form of alphanumeric text entry. Text input is one of the most complicated types of control. The complexity is increased due to the fact that users find it difficult to productively perform data input on a small mobile device and tend to avoid applications that require data input. In addition, users tend to accidentally delete text when doing so. This is due to the restrictive nature of the limited keyboards on the devices. For example, since “Clear” and “Back” functions are often assigned to the same key, users often make mistakes by misunderstanding the purpose of the keys and accidentally delete text when they want to go back, or go back when they want to delete text. Even when these functions are on separate keys, there may be problems, as on some devices the user presses the “Back” key intending to do a backspace, resulting in exiting the input screen and loss of the entered data.

To simplify text input for users, a text input control of the browser may include various features, including the following:

Growing Text Box: Text input is rendered as an input area, which will display as much text as will fit into its area when it is rendered. The size of the text box will grow, as necessary, as the user enters data into it. Text input must occur within the defined area which the text edit control displays.

Auto-Fill: Automatic filling of old text entries typed previously into a text input control helps users by not requiring them to type the same input again.

Word Scroll: The user can move the cursor by characters or words automatically and efficiently. Specifically, if the user presses the Up or Down arrow keys, then the arrows will first navigate the highlighting by characters until the first space is reached, and then the highlighting will be jumped by words. This feature provides for easier word editing.

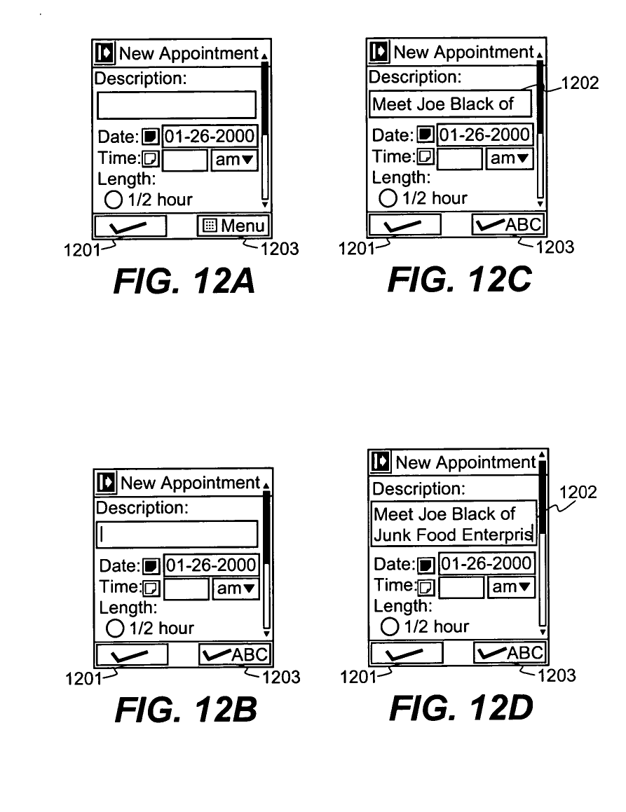

FIGS. 12A through 12D illustrate the Growing Text Box feature. When a text input control is selected, the user must press the first softkey 1201 which is an icon of a pen, to activate the text input control. After that, the user can type text (FIG. 12C), and if the user types more than the control can hold, then the text box 1202 will grow to accept more input, as shown by the difference between FIGS. 12C and 12D. While activated, the primary softkey 1201 becomes a checkmark icon to allow the user to end the editing session, and the secondary softkey 1203 becomes assigned for activating a context sensitive pop-up menu, as described above.

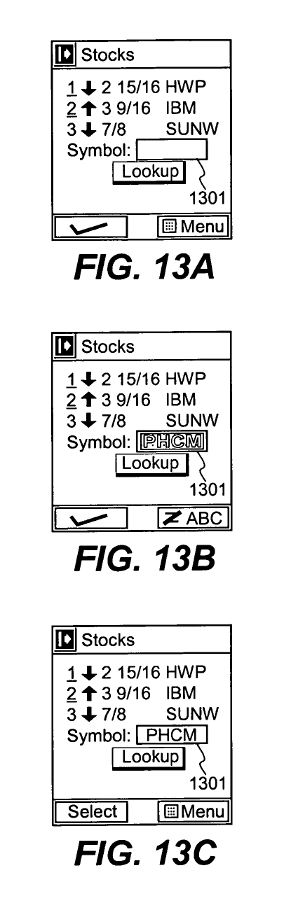

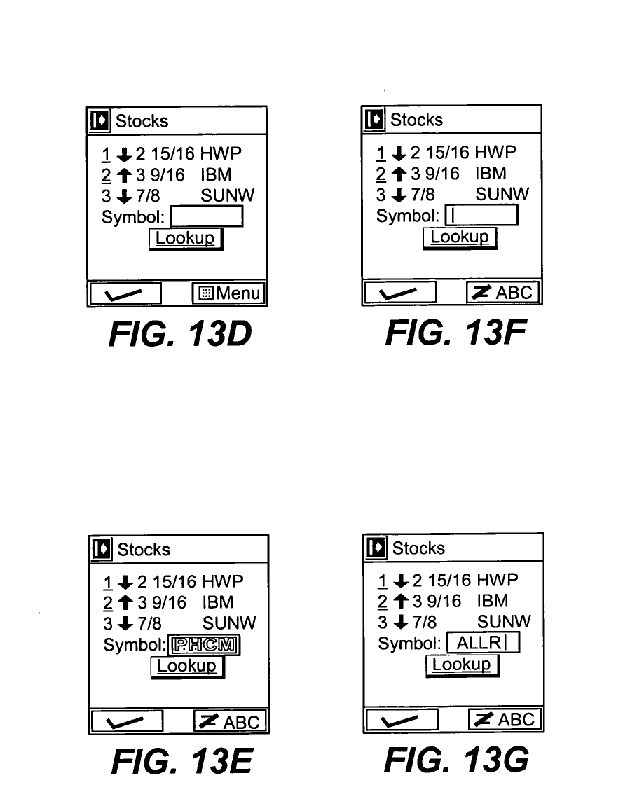

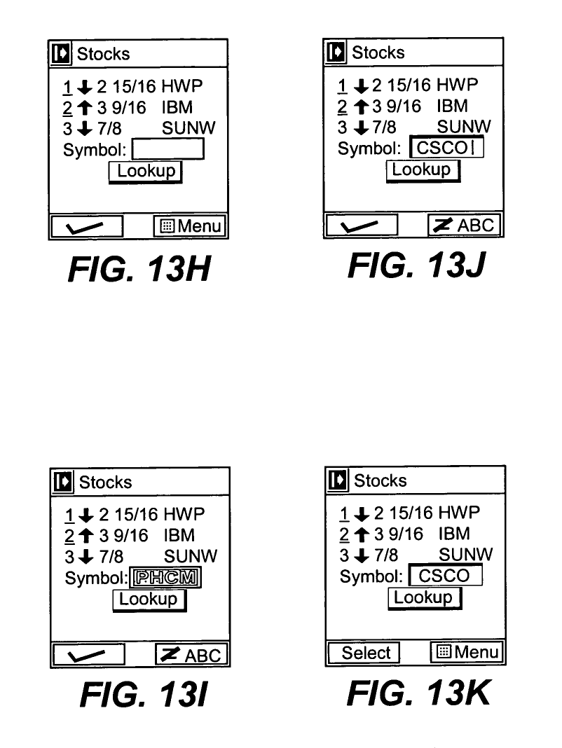

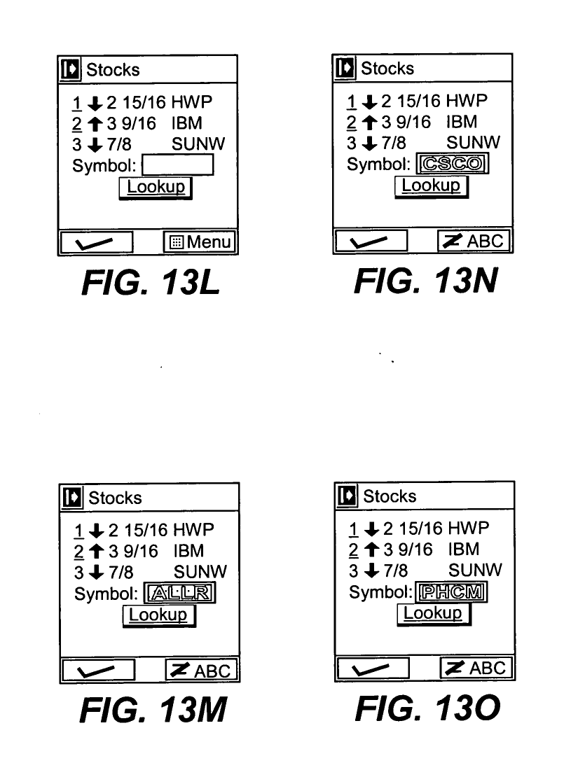

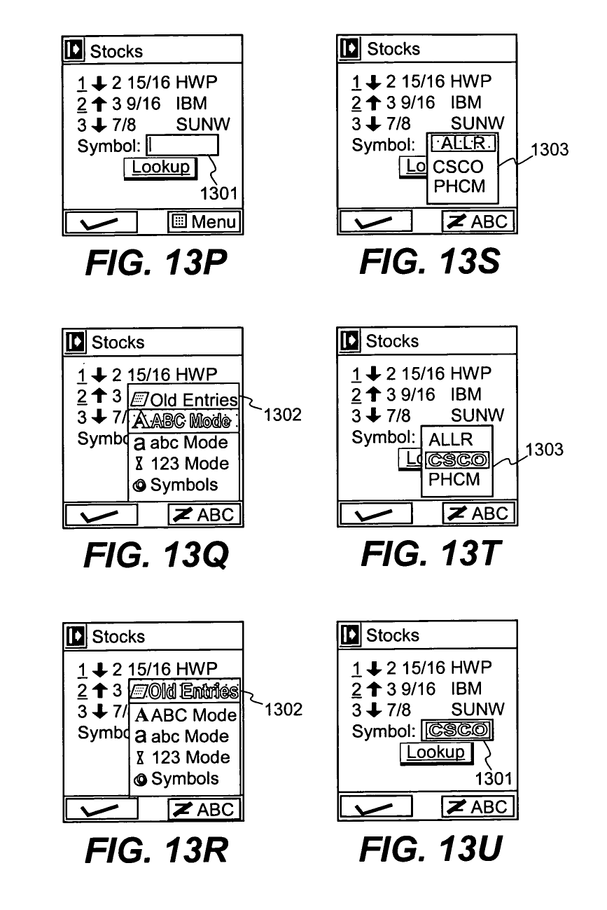

FIGS. 13A through 13I show a sequence of screens illustrating an example of the operation of the Auto-Fill feature. This feature enables the recalling of information input into text input fields for later use. This feature can be automatically turned on by default for all text input fields, and turned off by the developer should there be a sensitive field, such as for passwords or input fields that would not likely yield a need for this feature. The Auto-Fill feature can also be automatically turned off for fields marked with the password input format.

There are at least four possible ways to activate this feature:

The user activates a text input control that was already filled out in the past: When the user activates a text input control that has been filled out in the past, it will activate with the last typed input selected for the user.

The user selects “Old Entries” from a context sensitive pop-up (such as described above): This is a discoverable way for the user to select from other old input into the text input control.

The user presses the arrow keys after activating a control that has been filled in: If the user activates a control that has had input in the past, the last input is displayed immediately, and the user can use arrow keys to find other input.

The user starts typing input that matches old input: If the user starts to type in input that matches an old input, then the input field will be filled in with the rest of the word selected. The user can stop typing and accept the entire word or phrase.

Internally, the browser may cache old input according to a set of rules, such as the following, for example:

Cache up to 10 inputs for each field

Cache only the first 50 characters; and

Cache up to 20 fields, discarding by oldest fields by date of last use.

Regarding the first way of activating the Auto-Fill feature, consider the stock input example. FIGS. 13A through 13C show a sequence of displays for an example of what happens if the user uses the same application a second time. In this example, merely activating the Symbol text input control causes the old input, “PHCM”, to be automatically inserted into the text box 1301. In this case, assume that is what the user wanted, so the user presses the checkmark button (softkey) to accept the input and can now look up the value.

For one embodiment, the user has the following choices upon activating a field and causing pre-filled input:

Accept the input (as above).

Press “CLR” to clear the input, as shown in FIGS. 13D through 13G: This approach allows the user to type into a fresh empty field.

Type over input by typing any characters on keypad, as shown in FIGS. 13H through 13K: This approach skips the “CLR” step from above.

Press the arrow keys to sequence through other old input, as shown in FIGS. 13L through 13O: Here the user could press the up/down or left/right arrow keys immediately after entering a field to see other old input. In this example, the input is displayed from most recent input (e.g., FIG. 13L) to oldest (e.g., FIG. 13O) if the user presses the Down or Left arrow keys. If the user presses the Right or Up arrow keys, then the next more recent input is shown, or the oldest input if the user is viewing the last input.

A potential problem with the last example is that the user must already know how the arrow keys work for this approach to work. This approach is not as easily discoverable as the other approaches, so there should be a more discoverable way of finding old input as well. To compensate for this, an “Old Entries” feature can be added to a context sensitive pop-up (such as discussed above) when there are old entries to be pasted, as shown in FIGS. 13P through 13U. Selection of the “Old Entries” entry 1302 (FIG. 13R) brings up a pop-up menu, list, or dialog 1303 (FIG. 13S) over the text input field, with a list of previously used input values for the field, which allows the user to select an old input value to be pasted into the field. The pop-up 1303 works as any other conventional pop-up does, but disappears after a selection is made, leaving the input in the field 1301 (FIG. 13U). If the user scrolls off the pop-up 1303, he can dismiss it without making a selection.

In case the user does not discover or understand the “Old Entries” feature, there can be a third shortcut for filling out fields as the user types. If the user starts typing something that matches an old input, the old input value is completed and selected as the user types, allowing the user to make a quick accept as well.

VIII. Symbol Entry

When inputting information into a wireless communications device, the user may wish to input one or more symbols, as opposed to text or numbers. For example, the user might wish to input the “@” symbol to abbreviate the word “at” when recording the location of an appointment or when entering an email address. Conventional wireless devices that have no direct input device can be difficult to operate for purposes of symbol entry. Many wireless devices require a user to input symbols by repeatedly pressing a particular key to scroll through a list of symbols, which are displayed one at a time on the device's display. This process can be time-consuming and annoying to the user, particularly if there are many symbols to scroll through. If the device allows scrolling through the symbols in only one direction, as is often the case, the user may become frustrated if he inadvertently passes the symbol he wanted, since he will then have to scroll through the entire list again.

Other wireless devices allow the user to enter a symbol entry mode by activating one of the softkeys. This action causes the entire display to switch into the symbol mode to display a page of selectable symbols. The user then activates another softkey to flip through pages of selectable symbols. A problem with this approach is that it is not always intuitive for the user, such that the user may become confused about how to page through or select the symbols or how to exit the symbol entry mode.

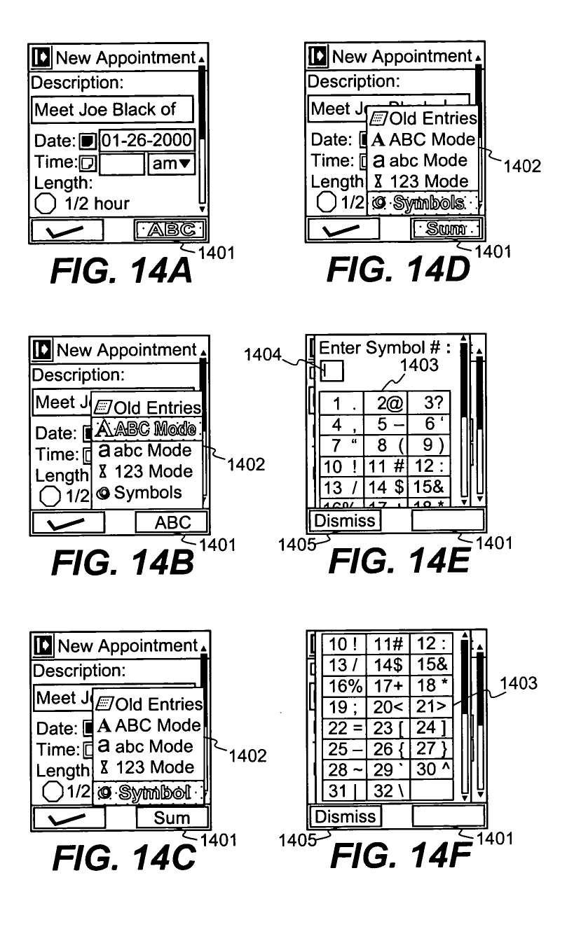

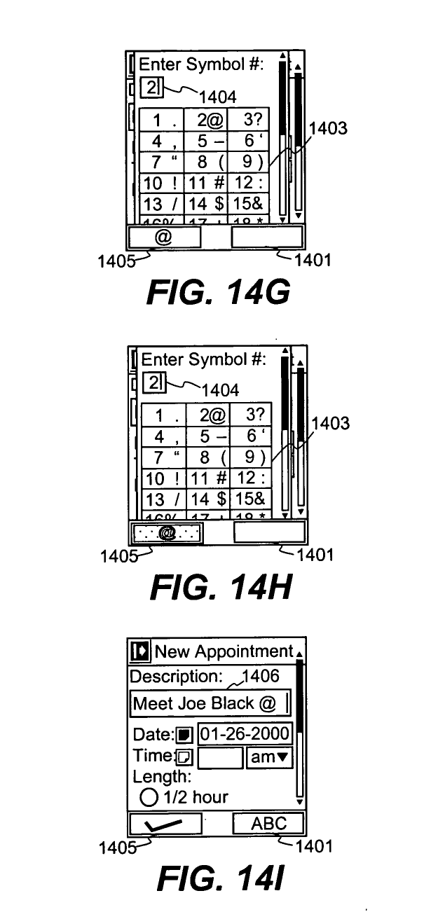

Accordingly, a symbol entry mode of the browser may be designed to operate as follows. To facilitate description, assume that the device is in the text entry mode for entering a new appointment, as shown in FIG. 14A. First, the user presses the second (right) softkey 1401 to activate the context sensitive pop-up menu. As shown in FIG. 14A, the first screen shows the second softkey 1401 being pressed, but not released yet. The second softkey 1401 is then released by the user to cause the softkey menu 1402 to be displayed (FIG. 14B). The user then scrolls down to select the “Symbols” item (FIG. 14C). The user presses the second softkey 1401 to select “Symbols” (FIG. 14D) in the context sensitive pop-up menu 1402, causing activation of the Symbol mode, in which the Symbol Picker table 1403 appears (FIG. 14E).

The Symbol Picker table 1403 is displayed as a pop-up with a text edit control 1404 already activated for typing in the symbol number. The symbol table shows all of the symbols that the user can choose from. The first softkey 1405 is labeled “Dismiss” to allow the user to dismiss the dialog without typing a symbol. Note that the second softkey 1401 is inactive.

The user may scroll up and down in the Symbol Picker table to locate a desired symbol, as shown in FIG. 14F. This is an optional action performed to show the content of the dialog; the user is not required to scroll down in order to make a selection. That is, a symbol need not be in view to be selected.

To select a symbol, the user first types the number of the desired symbol (FIG. 14G). As the user types, the first (left) softkey 1405 changes from “Dismiss” to the matching symbol. If the user continues to type, the symbol on the first softkey 1405 will continue to change to match the symbol represented by the number the user types. The user then presses the first softkey 1405 to select the symbol (FIG. 14H). When the user releases the first softkey 1405, the symbol is inserted at the insertion point in the original text input control 1406 (FIG. 14I).

Hence, the above-described symbol entry feature provides a scrollable list of symbols, which displays multiple symbols simultaneously to avoid the need to repeatedly press a button to toggle between symbols. The feature does not consume the entire display, however, so that the user can more easily maintain context.

IX. Dual Feedback for Softkey Activated Controls

As noted above, softkeys are labels displayed above physical (hardware) keys that operate the function of the softkeys, in the manner described above. In early browsers, softkeys are simply labels with keys below them that perform the action indicated by the softkey label on the screen. Typically, the action takes place with no user feedback, such that users do not always see the relationship between the physical key and the softkey label that specifies its operation. This lack of feedback often causes users to not understand what underlying behavior will occur when pushing the physical key.

In more-recent graphical browsers with “real” buttons, such as push buttons, icon buttons, and radio buttons, an opportunity presented itself to also make the softkey buttons look more graphical or 3D-like. However, users still may not recognize that the softkey label and the corresponding physical key are related. Also, with the more-recent GUIs there is additional need for feedback to the user to show the user that he is properly operating on the correct control on the screen.

Consider an example in which there are many radio buttons displayed. The user scrolls to select one radio button with physical arrow keys, but the user is unsure which physical keys should be pressed to activate the selected radio button. User feedback is required for both the physical key and the control being acted on. Accordingly, the browser of the wireless device may provide improved feedback to the user when activating softkeys, as will now be described.

Additional end-user feedback is added, in the form of making the softkey label into a visual button that visually “depresses” on the display as the corresponding physical key is pressed. In other words, the softkey label appears to be pressed down when the user presses down the physical key, and that the softkey label appears to be released (unpressed) when the physical key is released. Hence, the wireless device provides dual feedback. The user can use the arrow keys to select a control on the screen, such as a radio button, checkbox, or push button, and then when the user presses the physical key, the softkey label and the control on the display will both depress simultaneously to help the user understand that the softkey is used to operate the control.

Thus, pressing the physical key causes a dual action: When the user presses down on the physical key, both the softkey label button depresses visually on the display, and the control visually depresses on the display. When the user releases the physical key, the softkey label returns to its original state at the same time that the control returns to its previous state.

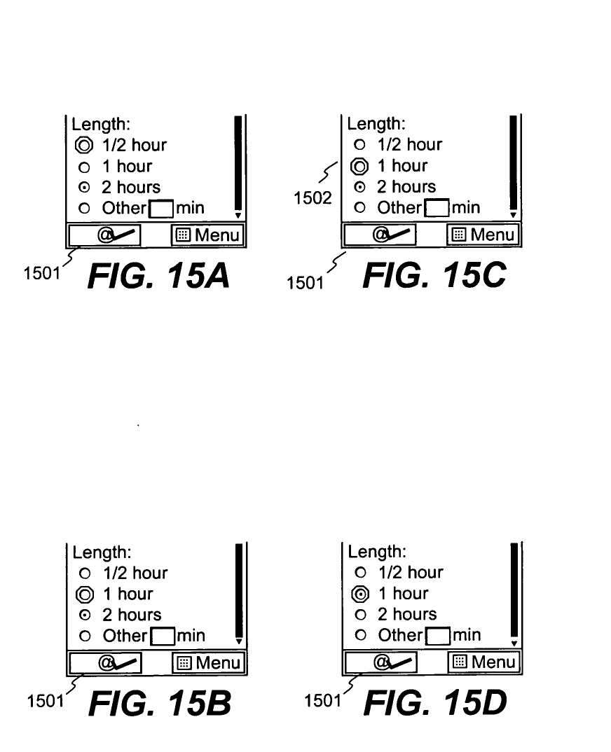

FIGS. 15A through 15D show a series of screens for an example that demonstrates how this dual feedback technique operates. Table 9 describes the operations and effects shown in FIGS. 15A through 15D. In this example, the user traverses through radio buttons to select one to activate, and then the individual steps associated with pressing the physical key associated with the softkey that activates the radio button are shown.

TABLE 9
Dual Feedback for Softkey Activated Controls

| Action | Results/Comment |
|---|---|
| Start -- FIG. 15A. | The “½ hour” radio button |
| Four radio buttons are | has a border around it to show the user with |
| displayed. | visual feedback which radio button is currently |
| | selected. |
| | The first (left) softkey label 1501 has an icon that |
| | shows that the softkey will operate on the radio |
| | button if the user selects it. |
| | It is very common for first-time users to discover |
| | that the up and down arrow keys on the device will |
| | move the highlighted selection, but they often are |
| | confused about how to operate on the control they |
| | select once it is selected. New users rarely find it |
| | intuitive that the softkey is the control to press to |
| | activate the radio button on earlier browsers that do |
| | not provide dual feedback. |
| FIG. 15B. | The “1 hour” radio button is now selected. |
| The user presses the down | Scrolling with the arrow keys only selects the radio |
| arrow key on the wireless | button, but does not activate it. Notice how “2 |
| device to select the | hours” is the activated radio button. |
| next radio button. | |
| FIG. 15C. | Both the radio button and the first softkey label |
| The user presses the | 1501 are shown depressed. The first softkey label is |
| physical key corresponding | indicated as being in the depressed “position” |
| to the first softkey | by its more-prominent border 1502 in comparison to its |
| button label (e.g., | appearance in FIGS. 15A and 15B. This dual |
| button 220 in FIG. 2). | visual feedback alerts the user to the softkey |
| FIG. 15C shows the screen | functionality so that the user is conditioned to look |
| while the button is being | for its label to know what will happen. It also |
| pressed down, but not | shows the control being activated on the screen (in |
| yet released. | this case the “1 hour” radio button) in a |
| | depressed state, so the user is clear he is performing |
| | the function he is attempting to perform. The “1 |
| | hour” radio button is indicated as being activated |
| | by its darker shading relative to its appearance in FIGS. |
| | 15A and 15B. |
| | Adding this dual feedback makes the interface |
| | easier to learn for beginners. Users learn quickly |
| | how to associate softkey labels with the physical |
| | keys that activates them, as well as how controls |
| | work, such as the radio button in this example. |
| FIG. 15D. | The “1 hour” radio button is now selected |
| The user releases the physical | and both the radio button and the softkey label 1501 |
| key associated with the left | return to their previous (unpressed) state. |
| softkey. | |

Thus, a method and apparatus for providing a microbrowser with a Graphical User Interface (GUI) in a hand-held wireless communication device have been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

What is claimed is:

1. A hand-held wireless communication device comprising:
a processor;
a display; and
a storage device having a browser stored therein, which when executed by the processor:
persistently displays an icon in a predetermined part of each of a plurality of display screens of hyperlinked content, the icon representing a pop-up browser menu that contains a plurality of items representing browser-specific features;
responds to user selection of a predetermined selectable item in any of the display screens by providing a user-perceivable indication that the pop-up browser menu is currently selectable; and
responds to a selection input when the pop-up browser menu is currently selectable by displaying the pop-up browser menu.

2. A hand-held wireless communication device as recited in claim 1, wherein:
the hand-held wireless communication device further comprises a selection control and a set of directional controls for moving a selection indicator bi-directionally along only a single axis; and
the hand-held wireless communication device lacks a direct pointing device;
and wherein the pop-up browser menu can be accessed by a user using only the set of directional controls and the selection control.

3. A hand-held wireless communication device as recited in claim 1, wherein the predetermined part of each of the display screens is a title bar of each of the display screens.

4. A hand-held wireless communication device as recited in claim 1, wherein the predetermined selectable item is a top selectable item in any of the display screens.

5. A hand-held wireless communication device comprising:
a processor;
a display; and
a storage device having a browser stored therein, which when executed by the processor:
persistently displays an icon in a title bar of each of a plurality of display screens of hyperlinked content, the icon representing a pop-up browser menu including a plurality of items representing browser-specific features;
responds to user selection of a top selectable item in any of the display screens by highlighting the icon to indicate the pop-up browser menu is selectable; and
responds to a selection input when the icon is highlighted by displaying the pop-up browser menu.

6. A hand-held wireless communication device as recited in claim 5, wherein:
the hand-held wireless communication device further comprises a selection control and a set of directional controls for moving a selection indicator bi-directionally along only a single axis; and
the hand-held wireless communication device lacks a direct pointing device;
and wherein the pop-up browser menu can be accessed by a user using only the set of directional controls and the selection control.

7. A method of providing a browser for a hand-held wireless communication device which lacks a direct pointing device, the method comprising:
persistently displaying an icon in a predetermined part of each of a plurality of display screens of hyperlinked content, the icon representing a pop-up browser menu including a plurality of items representing browser-specific features;
responding to user selection of a predetermined selectable item in any of the display screens by providing a visually perceivable indication the pop-up browser menu is selectable; and
responding to a selection input when the pop-up browser menu is selectable by displaying the pop-up browser menu.

8. A method as recited in claim 7, wherein:
the hand-held wireless communication device further comprises a selection control and a set of directional controls for moving a selection indicator bi-directionally along only a single axis; and
the pop-up browser menu can be accessed by a user using only the set of directional controls and the selection control.

9. A method as recited in claim 7, wherein the predetermined part of each of the display screens is a title bar of each of the display screens.

10. A method as recited in claim 9, wherein the predetermined selectable item is a top selectable item in any of the display screens.

11. A method of providing a browser for a hand-held wireless communication device which lacks a direct pointing device, the method comprising:
persistently displaying an icon in a title bar of each of a plurality of display screens of hyperlinked content, the icon representing a pop-up browser menu including a plurality of items representing browser-specific features;
responding to user selection of a top selectable item in any of the display screens by highlighting the icon to indicate the pop-up browser menu is selectable; and
responding to a selection input when the icon is highlighted by displaying the pop-up browser menu.

12. A method as recited in claim 11, wherein:
the hand-held wireless communication device further comprises a selection control and a set of directional controls for moving a selection indicator bi-directionally along only a single axis; and
the pop-up browser menu can be accessed by a user using only the set of directional controls and the selection control.

13. A machine readable program storage medium having stored therein a browser usable by a hand-held wireless communication device having a display but lacking a direct pointing device, wherein the browser, when executed on the hand-held wireless communication device, performs a method comprising:
persistently displaying an icon in a title bar of each of a plurality of display screens of hyperlinked content, the icon representing a pop-up browser menu including a plurality of items representing browser-specific features;
responding to user selection of a top selectable item in any of the display screens by highlighting the icon to indicate the pop-up browser menu is selectable; and
responding to a selection input when the icon is highlighted by displaying the pop-up browser menu.

14. A machine readable program storage medium as recited in claim 13, wherein:
the hand-held wireless communication device further comprises a selection control and a set of directional controls for moving a selection indicator bi-directionally along only a single axis; and
the pop-up browser menu can be accessed by a user using only the set of directional controls and the selection control.

15. A mobile communication device comprising:
a display device;
means for providing a user of the mobile communication device with two-way voice communication over a wireless network;
means for persistently displaying on the display device an icon in a predetermined part of each of a plurality of display screens of hyperlinked content, the icon representing a pop-up browser menu that contains a plurality of items representing browser-specific features;
means for responding to user selection of a predetermined selectable item in any of the display screens by providing a user-perceivable indication that the pop-up browser menu is currently selectable; and
means for responding to a selection input when the pop-up browser menu is currently selectable by displaying the pop-up browser menu.
